(19) United States
(12) Patent Application Publication
(10) Pub. No.: US 2008/0183597 A1
(43) Pub. Date: Jul. 31, 2008

(54) Visual and spatially-oriented real estate valuation and best comparables report generation system and method

(76) Inventors: Ramu Veerappan, Watchung, NJ (US); Siddhartha Som, Fresh Meadows, NY (US)

Correspondence Address: MILES & STOCKBRIDGE PC, 1751 PINNACLE DRIVE, SUITE 500, MCLEAN, VA, 22102-3833, US

(21) Appl. No.: 12/007,891

(22) Filed: Jan. 16, 2008

Related U.S. Application Data
(60) Provisional application No. 60/880,417, filed on Jan. 16, 2007.

(51) Int. Cl. G06Q 30/00

(52) U.S. Cl. 705/27

(57) ABSTRACT

Real estate valuation system and method generally, and more specifically, a visual and spatially-oriented real estate valuation and best comparables report generation system and method.

### CROSS REFERENCE TO RELATED APPLICATIONS

This application claims benefit of priority to U.S. Provisional Patent Application No. 60/880,417, filed Jan. 16, 2007 and which is herein incorporated in its entirety by reference.

### TECHNICAL FIELD

Real estate valuation system and method generally, and more specifically, a visual and spatially-oriented real estate valuation and best comparables report generation system and method.

### BRIEF DESCRIPTION OF THE DRAWINGS

Non-limiting and non-exhaustive embodiments of the present invention are described with reference to the following figures, wherein like reference numerals refer to like parts throughout the various views unless otherwise precisely specified.

FIG. 1 is a functional block diagram of a visual and spatially-oriented real estate valuation and best comparables report generation system 100, in accordance with an embodiment of the present invention.

FIG. 2 is a screen shot of a screen from a Microsoft Map Point application with an implementation of the system incorporated into the Map Point application as a tool, in accordance with an embodiment of the present invention.

FIG. 3 is a screen shot of a login window that appears over the screen shot of FIG. 2 after the SpatialComps option is selected, in accordance with an embodiment of the present invention.

FIG. 4 is a screen shot of a screen from the Microsoft Map Point application of FIG. 2 with the main work area interface of the system displayed, in accordance with an embodiment of the present invention.

FIG. 5 is a screen shot of the screen of FIG. 2 with a variable container popup box 500 displayed, in accordance with an embodiment of the present invention.

FIG. 6 is screen shot of a screen from the application after the user clicked on the OK button in FIG. 5, in accordance with an embodiment of the present invention.

FIG. 7 is a detailed screen shot of the grid area of the screen in FIG. 6, in accordance with an embodiment of the present invention.

FIG. 8 is screen shot of a screen from the application after the user selected a subject property in FIG. 7, in accordance with an embodiment of the present invention.

FIG. 9 is a screen shot of the screen in FIG. 7 after the user selects comps 1-4 in the grid area, in accordance with an embodiment of the present invention.

FIG. 10 is a screen shot of the screen with the manual adjustment form overlaid over the zoomed-in view of a section of the local area map, in accordance with at least one embodiment of the present invention.

FIG. 11 is a screen shot of a comparables report with manual adjustment, in accordance with an embodiment of the present invention.

FIG. 12 is a screen shot of a comparables report without manual adjustment, in accordance with an embodiment of the present invention.

FIG. 13 is a screen shot of the screen with an archive request window manual adjustment form, in accordance with an embodiment of the present invention.

FIG. 14 is a screen shot of a screen of an aerial view of live local web page, in accordance with an embodiment of the present invention.

FIG. 15 is a screen shot of a screen of an aerial view of live local web page, in accordance with an embodiment of the present invention.

FIG. 16 is a screen shot of the screen with a comps wizard form 1610 overlaid over a local area map, in accordance with at least one embodiment of the present invention.

FIG. 17 is a screen shot of a screen of a local area map with subject properties having a sales price in according to the search criteria, in accordance with at least one embodiment of the present invention.

FIG. 18 is a screen shot of the screen with a sales analyst form 1810 overlaid over a local area map, in accordance with at least one embodiment of the present invention.

FIG. 19 is a screen shot of a screen of a local area map with subject properties having been sorted according to the style search criteria in FIG. 18, in accordance with at least one embodiment of the present invention.

FIG. 20 is an example printout of the sorted map of FIG. 19, in accordance with an embodiment of the present invention.

FIG. 21 is a screen shot of the screen with a stratification (i.e., data mapping) form overlaid over a local area map, in accordance with at least one embodiment of the present invention.

FIG. 22 is a screen shot of a screen of a local area map with subject properties having been sorted according to the WF search criteria specified in FIG. 21, in accordance with at least one embodiment of the present invention.

FIG. 23 is a screen shot of a screen with a view adjustment grid overlaid over a local area map, in accordance with at least one embodiment of the present invention.

FIG. 24 is a screen shot of a screen with a build adjustment grid overlaid over a local area map, in accordance with at least one embodiment of the present invention.

FIG. 25 is a screen shot of a screen of a local area map with subject properties in a territory having been identified according to the square footage of living area (sfla), in accordance with at least one embodiment of the present invention.

FIG. 26 is a screen shot of the screen of FIG. 25 with an import comps/subject window overlaid over the local area map of FIG. 25, in accordance with at least one embodiment of the present invention.

FIG. 27 is a screen shot of the screen of FIG. 26 with a Create New DataBase window overlaid over the import comps/subject window and the local area map of FIG. 26, in accordance with at least one embodiment of the present invention.

FIG. 28 is a screen shot of a screen of a local area map with subject properties in a territory having been identified according to the square footage of living area (sfla), in accordance with at least one embodiment of the present invention.

FIG. 29 is a screen shot of the screen of FIG. 28 with an archive subject window overlaid over the local area map of FIG. 28, in accordance with at least one embodiment of the present invention.

FIG. 30 is a screen shot of the screen of FIG. 28 with an archive comps window overlaid over the local area map of FIG. 28, in accordance with at least one embodiment of the present invention.

FIG. 31 is a screen shot of a screen with a local area map with subject properties in a territory having been identified according to the square footage of living area (sfla), in accordance with at least one embodiment of the present invention.

FIG. 32 is a sample of a summary of batch comps results for a number of subject properties, in accordance with at least one embodiment of the present invention.

FIG. 33 is a flowchart of a method of providing spatially-oriented real estate valuations, in accordance with an embodiment of the present invention.

FIG. 34 is a flowchart of a method of providing spatially-oriented batch comparable real estate valuations, in accordance with an embodiment of the present invention.

FIG. 35 is a flowchart of a yet another method of providing spatially-oriented batch comparable real estate valuations, in accordance with an alternative embodiment of the present invention.

FIG. 36 is a screen shot of a web page of a system for providing home valuations showing available counties in which information is available to calculate a home valuation, in accordance with an alternative embodiment of the present invention.

FIG. 37 is a screen shot of a web page display of results from a search on a subject property using the system, in accordance with an alternative embodiment of the present invention.

FIG. 38 is the screen shot of FIG. 37 showing information on the subject property, in accordance with an alternative embodiment of the present invention.

FIG. 39 is a screen shot of the system from FIG. 38 after selecting the Property Info tab, in accordance with an alternative embodiment of the present invention.

FIG. 40 is a screen shot of the system from FIG. 38 or 39 after selecting the Sales Info tab, in accordance with an alternative embodiment of the present invention.

FIG. 41 is a screen shot of the system from FIG. 38, 39 or 40 after selecting the Assessment Values tab, in accordance with an alternative embodiment of the present invention.

FIG. 42 is a screen shot of the system from FIG. 38, 39, 40 or 41 after selecting the Internal Values tab, in accordance with an alternative embodiment of the present invention.

FIG. 43 is a screen shot of the system from FIG. 37 after changing the Radius search value from 1.0 miles to 2.0 miles, in accordance with an alternative embodiment of the present invention.

### DESCRIPTION

In accordance with one or more embodiments of the present invention, a visual and spatially-oriented real estate valuation and best comparables report generation system and method may be designed for use by the public to obtain free home values (FHVs) and/or the Real Estate Assessment Community as an automated valuation model (AVM), an indexed-AVM and/or to provide batch comparable sales valuations. In general, the pubic user will not be charged for preparing a valuation, so they will be limited to only prepare a single valuation at a time to prevent commercial users from using the free system to obtain mass valuations for free. The commercial user, after payment of an appropriate fee, may obtain AVMs, Indexed AVMs and batch comps.

In accordance with at least one embodiment of the present invention, the system and method may use a graphic information system (GIS) application such as, for example, but not limited to, Google Maps, MapPoint 2006, and the like to provide the mapping functionality of the system and provide a computer aided mass appraisal (CAMA). Alternatively, a dedicated GIS application may be created for use with the system and method. Regardless, the GIS application is, generally, pre-installed in the system on, for example, a Microsoft Windows XP platform.

In general, in accordance with one or more embodiments of the present invention, the system and method enable a user to select comparable properties directly from a map in the GIS application and then use the selected properties to prepare a valuation for a subject property. A predefined, but modifiable, territory around the subject property is automatically generated within which the user may select any of the properties located within the predefined territory for use to prepare the valuation. In addition to selecting which properties to use, the user is also able to selectively use spatial, aerial and traditional data about each property. This is in contrast to traditional comparables estimating programs that only provide the user with control over an adjustment grid, which specifies an area (for example, a circle with an adjustable radius) around the subject property. While the systems and method of the present invention may also use an adjustment grid feature, they do so at the back-end of the valuation process as an equalization mechanism.

In accordance with one or more embodiments of the present invention, the system and method may be developed with the Visual Studio 2005 (IDE) using C# language and built-in Reporting Services. The system and method may make use of the GIS application's interoperable “Dynamic Link Library (DLL)”, for example, for MapPoint this DLL is called Interop.Mappoint.dll. Interop.Mappoint.dll is a file that is of an ActiveX type and exposes MapPoint features and functionalities to other applications that use the same, by referencing and including into the project source.

In accordance with one or more embodiments of the present invention, system and method may make use of an Extensibility option provided by the Visual Studio 2005 IDE. The extensibility feature enables custom developed applications to act as an “Add-in” to the primary GIS application, for example, but not limited to, Google Maps and MapPoint objects, thereby allowing such applications to fetch, manipulate and manage GIS application functions and make use of inherent features including rendering, data handling, analysis, etc. Over and above the available exposed application programming interfaces (APIs), any additional features may be integrated into the product as needed.

In accordance with one or more embodiments of the present invention, for example, in those embodiments in which MapPoint is used, other MapPoint Tools that may be used include, for example, but are not limited to: MapLinxPro by Linxoft Solutions, MapLinX Pro is a full-fledged add-on query (database) tool that is integrated with MapPoint; a demographic analyzer by Spatial Point; Mapping Tools by Winwaed Software Technology; and Franson CoordTrans by Franson Technology, which is a geographic coordinate convertor tool for converting between different coordinate systems.

Alternative embodiments in accordance with the present invention may include: A Web enabled Spatial Comps; A ‘Change’ module for the Spatial Comps Database where data can be changed; A Customized version for the Appraiser (Real Estate/Bank) Community; Integrating with Map Cruncher (custom maps can be loaded, custom aerial pictures loaded, floor plans can be viewed etc.); Integrating with Google Earth; Integrating with Mappoint for the European Version; and Offering it to homeowners/buyers/general public on the web.

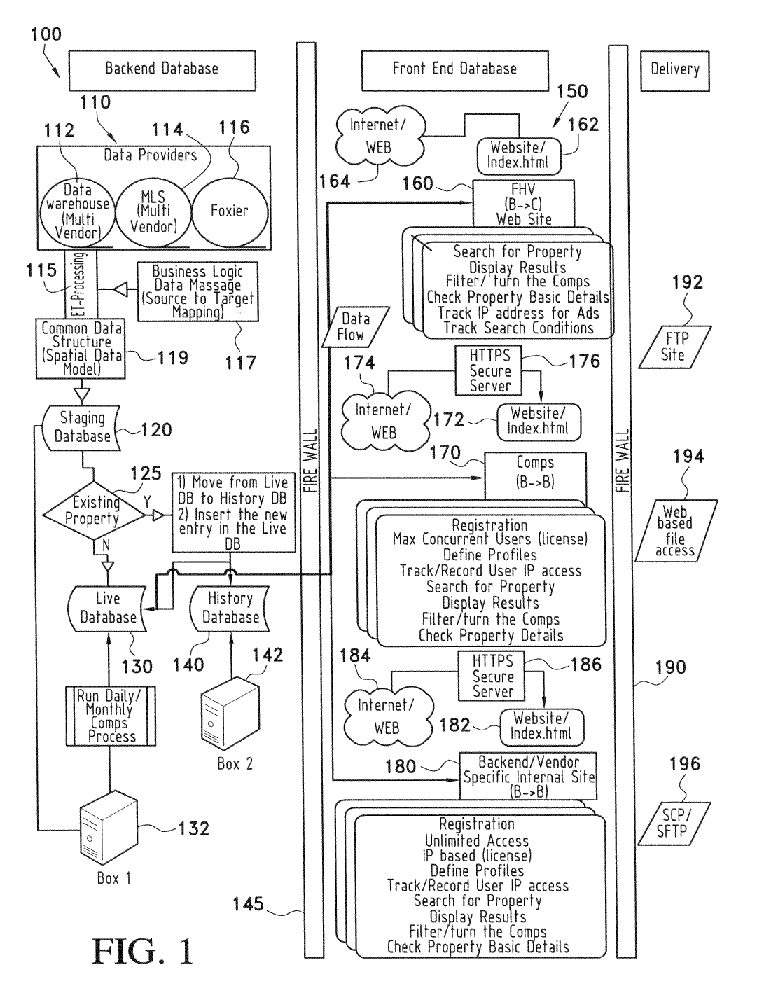

Embodiments of the present invention may be implemented in a client-server environment, as a web-based application, and/or as a stand alone application. FIG. 1 is a functional block diagram of a visual and spatially-oriented real estate valuation and best comparables report generation system 100, in accordance with an embodiment of the present invention. In general, in FIG. 1, the system is implemented around a backend database system 110 in which data on existing properties, which may also be referred to as “comparables,” in different geographic areas around the United States and/or the world may be maintained for use in preparing valuations. The data may be obtained from a variety of data providers, for example, but not limited to, a variety of data warehouses 112, a variety of different multiple listing services (MLS) 114. Several front-end database systems 160, 170, 180 may be in communication with the backend database system 110 via a firewall 145 and the front-end database systems 160, 170, 180 may be used to prepare valuations including, for example, but not limited to, a FHV database 160 for use mainly by the public to obtain free estimates of the value a property; an AVM database 170 for use mainly by business users (for example, but not limited to, banks, mortgage lenders, law firms specializing in property tax appeals, and the like) to prepare valuations for a property and/or properties; and a backend/vendor-specific (for example, but not limited to, home retailers, home inspection companies, title companies, mortgage bankers, and appraisal companies) internal site database 180 for providing the FHV; and/or AVM database information as a service to clients and/or employees of the backend/vendor.

In FIG. 1, data from each of the data providers 112, 114, 116 may be taken separately and/or in combination and may be processed using extract, transform, and load (ETL) processing 115 in which the data from the data providers is transformed 117 from their data mapping (i.e., format) to map the original data to the data mapping of the backend database system 100. All data used in the database as comps data is constantly being validated to ensure the quality of the data and updated at regular intervals to make sure the data is also current. After the data is transformed 117, the data may be loaded 119 into a data structure for the backend database system 110 and into a staging database 120. The staging database 120 is not required, but enables the ETL processing of new data to be continuously performed and the new data temporarily stored without constantly interrupting the remaining portions of the backend database system 110 from performing their tasks of providing valuations and estimates. The staging database 120 may be used to update a live database 130 and a history database 140 in the backend database system 110 at specific times, for example, as a batch process during historically determined “quiet” times for large quantities of updates and/or during historically determined “busy” times when the live database 130 and the history database 140 are temporarily not in use for, generally, smaller quantities of updates. Regardless, when data from staging database 120 is to be used to update the live database 130 and the history database 140, a check is first performed for each data record to determine 125 whether the property is already in the live database 130. If the data record for a given property is not in the live database 130, the record is stored to the live database 130, which will be accessed by the front end database systems to prepare valuations. If the data record for the given property is in the live database 130, first the record currently in the live database 130 may be moved to the history database 140 on, for example, but not limited to, a computer/server system 142, then, second, the new data record for the property may be stored in the live database 130 as a replacement for the old data record that was just moved to the history database 140.

In FIG. 1, staging database 120 may also be used to run daily and/or monthly comparables processes from the live database 130 via a computer/server system 132, which may also be used to store the live database 130.

In FIG. 1, the FHV database 160 may be accessed through a website 162 via firewall 145 on the Internet 164 by public users to obtain free estimates of the value a property. Functions available to the public users include, but are not limited to, searching for a specific property, displaying results of the search, and filtering/tuning the comparables, checking for basic details of a property, tracking IP addresses for future advertisements, and tracking search conditions entered by the users. In other words, public users will be able to filter/tune (i.e., narrow down) the search results by entering a specific range for property attributes, for example, area, location, year Built, etc. Similarly, the AVM database 170 may be accessed through a website 172 on a secure server 176 via firewall 145 on the Internet 174 for use mainly by business users to, in addition to preparing valuations for a property and/or properties, registering the business users, defining/controlling the maximum number of licensed users at each business, defining user profiles, tracking/recording user IP access information, searching for specific property information, displaying results, filtering/tuning the comparables, and checking for basic details of a property. Likewise, the backend/vendor-specific internal site database 180 may be accessed through a website 182 on a secure server 186 via firewall 145 on the Internet 184 for use mainly by backend/vendor users and/or customers to, in addition to providing FHV and/or AVM database information, registering the business users, providing unlimited access and/or defining/controlling the maximum number of licensed users at each business, defining user profiles, tracking/recording user IP access information, searching for specific property information, displaying results, filtering/turning the comparables, and checking for basic details of a property.

In FIG. 1, delivery of the valuation information may be accomplished from and of the websites 162, 172, 182 via a second firewall 190 to a file transfer protocol (FYP) site 192, a web based file access system 194, and/or a secure copy (SCP)/secure FTP (SFTP). For example, a system on which one or more embodiments of the present invention may be implemented includes, but is not limited to, a 2× Dual Core AMD Opteron 2216, 2×2×2.4 GHz; DDR RAM: 8 GB; Hard Drive: 2×500 GB; Operating System: Microsoft Windows Server 203 Standard Edition; and Database: Microsoft SQL Server Enterprise Edition. It is understood that other equivalent systems with different manufacturer's equipment, operating system and database may also be used.

A detailed example of how at least one embodiment of the present invention may operate is described below to provide further insight into the operation of the system and method.

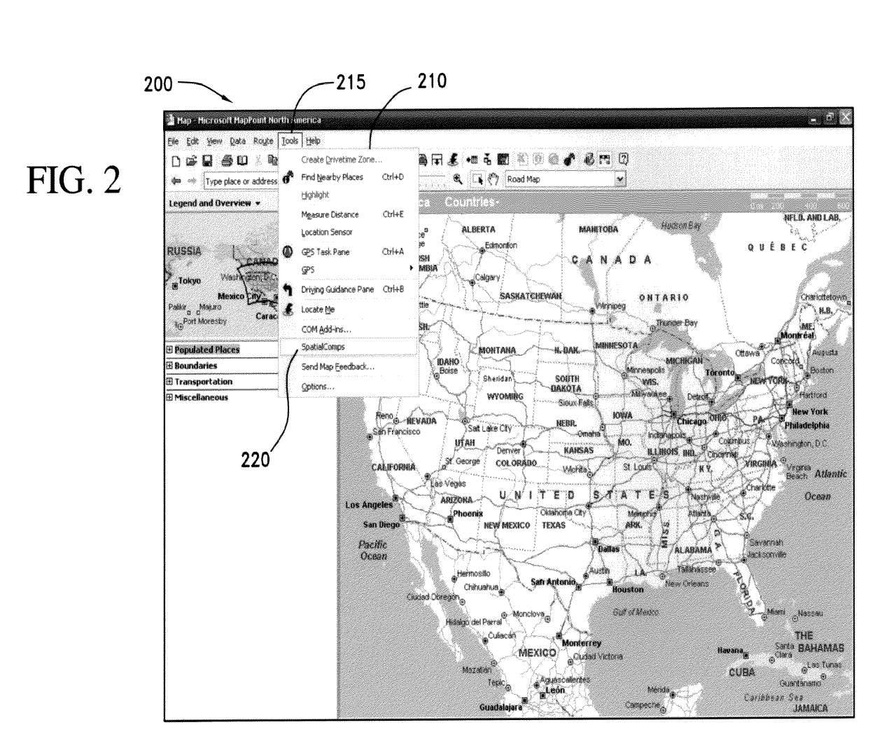

FIG. 2 is a screen shot of a screen 200 from a Microsoft Map Point application with an implementation of the system incorporated into the Map Point application as a tool, in accordance with an embodiment of the present invention. In FIG. 2, a pull-down menu 210 is shown from a “Tools” tab 215 on a tab line on the screen shot 200. On a third line from the bottom 220 is a “SpatialComps” option that, when selected, will start an embodiment of the present invention.

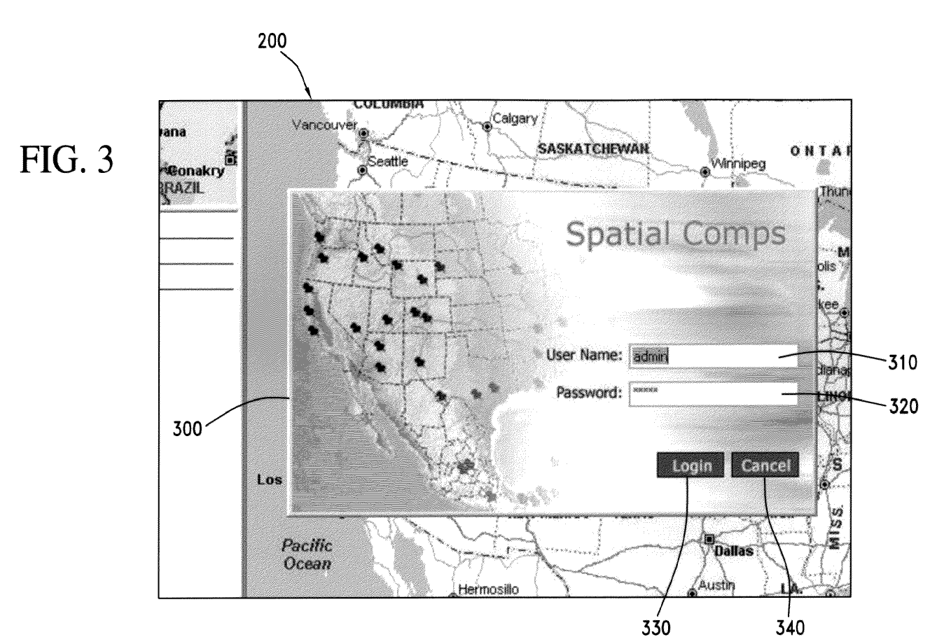

FIG. 3 is a screen shot of a login window 300 that appears over the screen shot 200 of FIG. 2 after the SpatialComps option 220 is selected, in accordance with an embodiment of the present invention. In FIG. 3, a user name box 310 is displayed to receive an entry of the user's name and a password box 320 is displayed to receive an entry of the user's password. A selectable Login button 330 is displayed below the password box 320 and may be selected after the user's name and password have been entered to login into the system. A Cancel button 340 is displayed next to the Login button 330 below the password box 320 and may be selected at any time to cancel the login process.

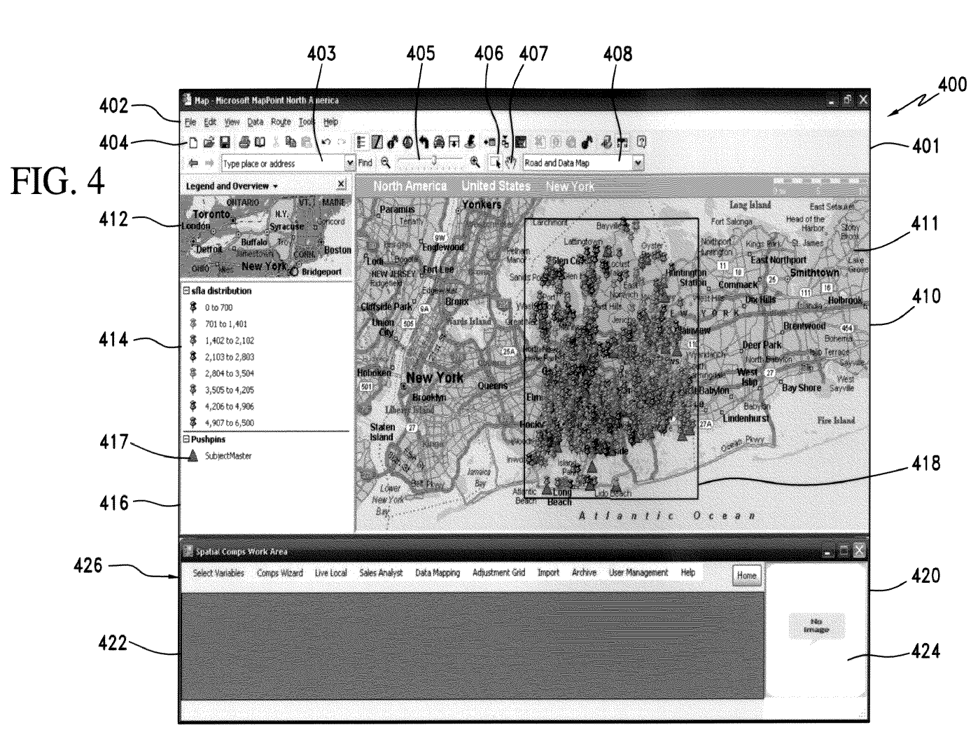

FIG. 4 is a screen shot of a screen 400 from the Microsoft Map Point application of FIG. 2 with the main work area interface of the system displayed, in accordance with an embodiment of the present invention. In FIG. 4, the interface has two screens cascaded horizontally, a top screen 410 that includes a tool bar 401, a Microsoft Map Point pictorial representation with a local area map 411 and a regional map 412, and a bottom screen 420 that is a work area for the system of the present invention in a grid format. The tool bar 401 may include a word toolbar 402, a place or address box 403 with pull-down menu option for entry/selection of a specific property address, an icon toolbar 404, a zoom control bar 405, a territory select tool button 406, grab icon button 407, and a road and data map box 408 with pull-down menu option for entry/selection of a specific road or data map. The bottom screen 420 may include a grid area 422 (which may also be referred to as a bucket and/or bucket area), an image area 424 for a picture of the property, and an appraisal/valuation work area word toolbar 426.

In FIG. 4, the top screen 410 may be populated with a default “sfla distribution” stratification area 414 on left hand side when there is data in the database and where sfla stands for square feet of living area. In FIG. 4, the pushpins may be color coded to represent different ranges of square feet, for example, but not limited to, a black pushpin may be used to represent properties with a sfla in the range of 0 to 700 square feet, an olive green pushpin may be used to represent properties with a sfla in the range of 701 to 1,401 square fee, a purple pushpin may be used to represent properties with a sfla in the range of 1,402 to 2,102 square fee, a dark blue pushpin may be used to represent properties with a sfla in the range of 2,103 to 2,803 square fee, a red pushpin may be used to represent properties with a sfla in the range of 2,804 to 3,504 square fee, a green pushpin may be used to represent properties with a sfla in the range of 3,505 to 4,205 square fee, a medium blue pushpin may be used to represent properties with a sfla in the range of 4,206 to 4,906 square fee, and a burgundy pushpin may be used to represent properties with a sfla in the range of 4,907 to 6,500 square fee.

In FIG. 4, below the stratification area 414 is a pushpin area 416 that includes a pushpin labeled “Subject Master” 417 that is denoted by a red triangle. A property identified as a subject master is a property for which a valuation is to be prepared. A rectangular box 418 within top screen 410 defines a territory on the map within which data from the system may be displayed for use in preparing a valuation. Each of the multicolored pushpins on the screen within rectangular box 418 represents a property that is stratified by sfla and has associated with it, its respective sale price and each such property may be referred to as a Comp or a Comparable. Together they may be referred to as Comps or Comparables.

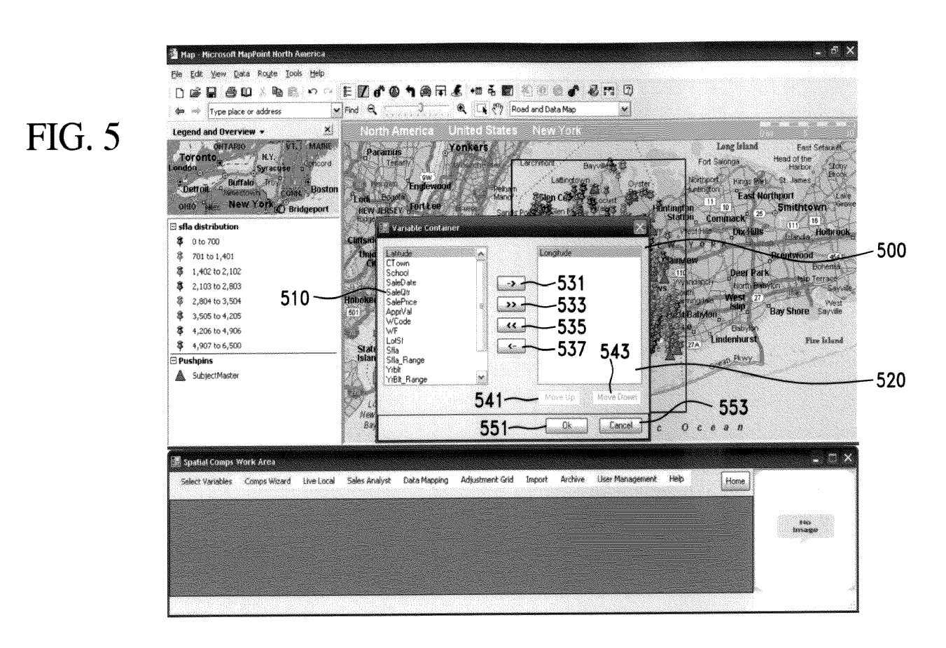

FIG. 5 is a screen shot of the screen 400 of FIG. 2 with a variable container popup box 500 displayed, in accordance with an embodiment of the present invention. In FIG. 5, the variable container popup box 500 displays all of the attributes associated with each of the Comps in the database for the user to select the ones that are to be displayed in the grid and used to calculate the valuation. An available attribute box 510 includes a scrollable list of all of the available attributes and a select attribute box 520 includes a scrollable, if necessary, list of the selected attributes to be used in calculating the valuation. The selected attributes may be moved from the available attribute box 510 to the selected attribute box 520 by highlighting an attribute in the available attribute box 510 and clicking on a move attribute right button 531. Alternatively, more than one attribute may be selected by holding down the control (Ctrl) key and selecting the desired attributes by right-clicking the mouse on the desired attributes and then clicking on the move attribute right button 531. If all attributes are to be selected, then the user need only click on a move all attributes right button 533. Similarly, attributes may be moved from the selected attribute box 520 back to the available attribute box 510 using a move all attributes left button 535 and/or a move attribute left button 537. When two or more attributes are moved into the selected attribute box 520, a move up button 541 and a move down button 543 become active and enable the user to change the order of the attributes in the selected attributes box 520. The top to bottom order in the selected attributes box 520 define the left to right order that the attributes are will be displayed in the grid area 422 of the bottom screen 420. An OK button 551 may be selected when the user has completed choosing which attributes are to be used and a Cancel button 553 may be used to exit the selection process without making any attribute selections.

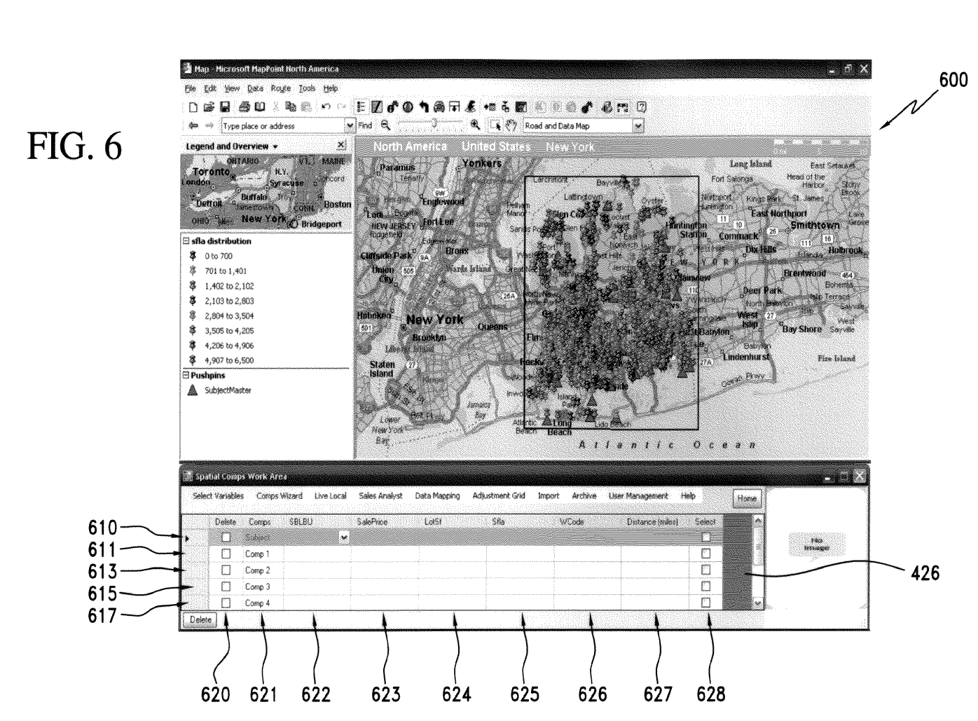

FIG. 6 is screen shot of a screen 600 from the application after the user clicked on the OK button 551 in FIG. 5, in accordance with an embodiment of the present invention. In FIG. 6, the chosen attributes are displayed in the grid area 422 with attributes as columns in the order in which they were listed in the selected attributes box 520. In a first row 610 in the grid area 422, is for a subject property for which the valuation is to be calculated. Rows 611, 613, 615, 617, etc. are for comparable properties that will be selectable after the subject property is selected in the first row 610. In FIG. 6, six attribute columns are shown as being selected in addition to several standard columns that are also displayed. The standard columns are a delete column 620 that includes a check box to indicate that the row should be deleted and not used to calculate the valuation; a comps column 621 that indicates whether the property is the subject property or a comp; and a select column 628 that indicates that the row should be used to calculate the valuation for the subject property.

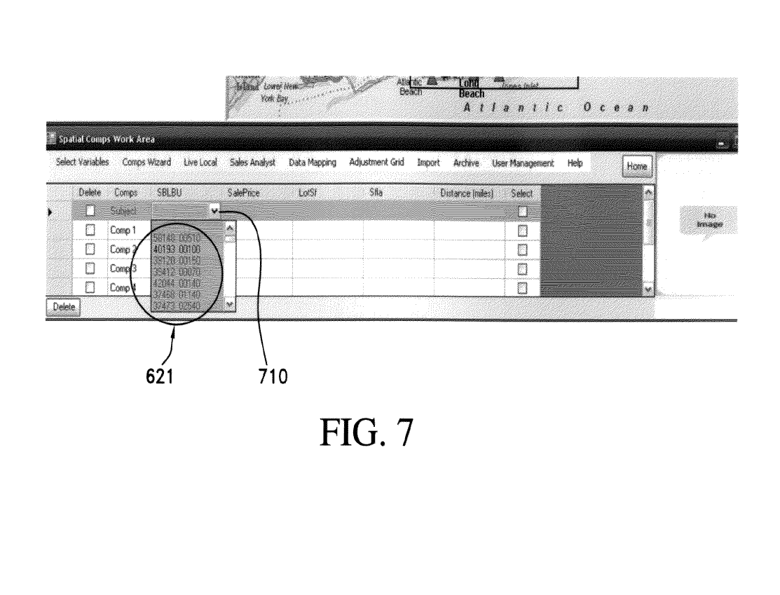

FIG. 7 is a detailed screen shot of the grid area 422 of the screen 600 in FIG. 6, in accordance with an embodiment of the present invention. In FIG. 7, the user has the option to select the subject property's identification number (SBLBU) from a drop down box 710. After selecting the SBLBU from the drop down box 710, comps within a given radius will be automatically populated into the grid area 422 in the rows for comps, sorted by their distance from the subject property. Alternatively, the user may drag and drop a subject property into the SBLBU column in the subject row 610 and the data for the subject property will be retrieved from the database.

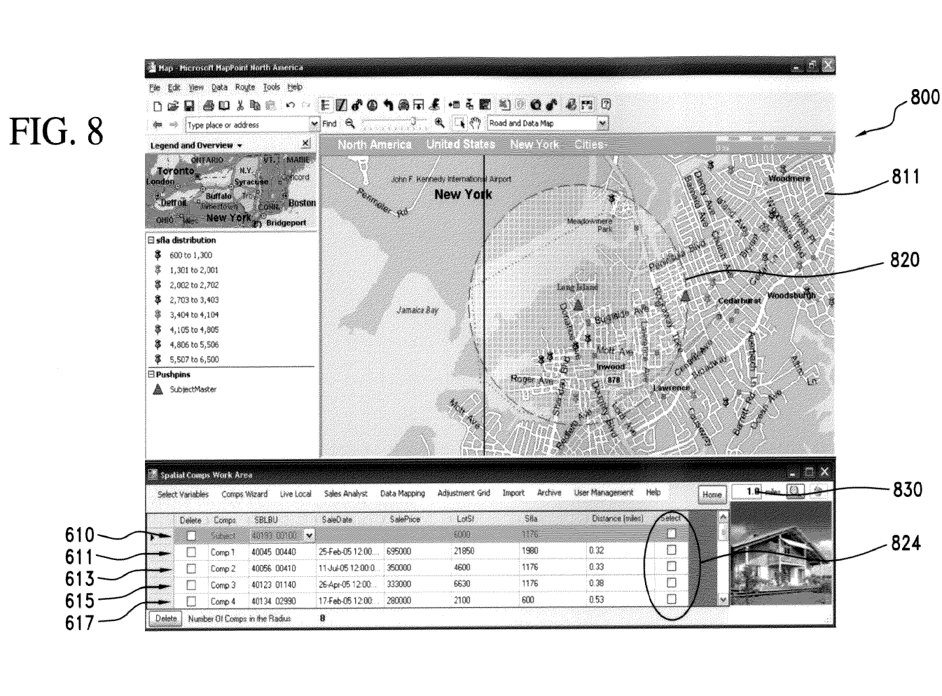

FIG. 8 is screen shot of a screen 800 from the application after the user selected a subject property in FIG. 7, in accordance with an embodiment of the present invention. In FIG. 8, the data for the subject property has been populated into the columns in a subject row 610; a zoomed-in view of a section 811 of the local area map 411 with a territory circle 820 with a predetermined radius 830 is drawn from the subject. For example, the radius 830 initially may be set at 1.0 miles, however, the radius 830 can be manually changed to any desired distance, and the territory circle 820 will be automatically recalculated from the current subject. A picture of the subject property may be included in image area 824. Data is automatically fetched from the database based on the selected attributes of the subject property and displayed in comp rows 611, 613, 615, 617. A distance is calculated from the subject property for each and every comp a user may drag and drop in to the grid area 422. If a comp is added to the grid area 422 that is outside the territory circle 820, the system will automatically recalculate and redraw the territory circle 820 to include the new comp within the territory circle 820. The select column 628 in the grid area 422 is provided with a check box for each comp to select which comps are to be used for an adjustment process.

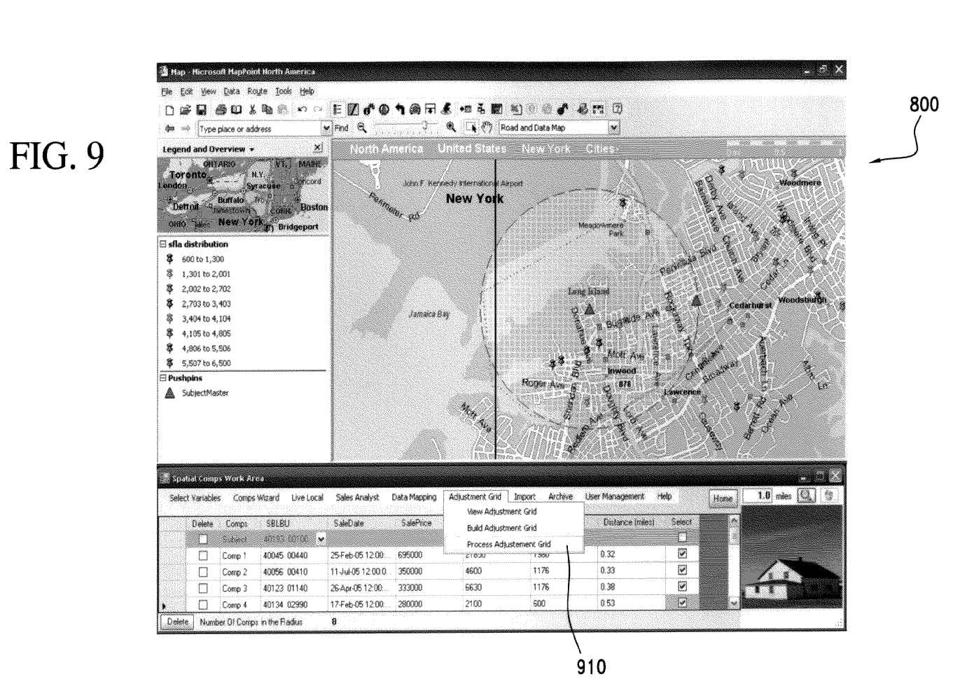

FIG. 9 is a screen shot of the screen 800 in FIG. 7 after the user selects comps 1-4 in the grid area 422, in accordance with an embodiment of the present invention. In FIG. 9, the user wants to process the selected comps by clicking on a Process Adjustment Grid menu option 910 in a menu bar 920 under an Adjustment Grid option 940 in the valuation work area word toolbar 426. After selecting on the process adjustment Grid, a message box pops up prompting the user to select whether to perform manual adjustment. If the user clicks yes on the popup message box to indicate that the user wants to perform a manual adjustment, a Manual Adjustment form 1010 pops up over screen 800.

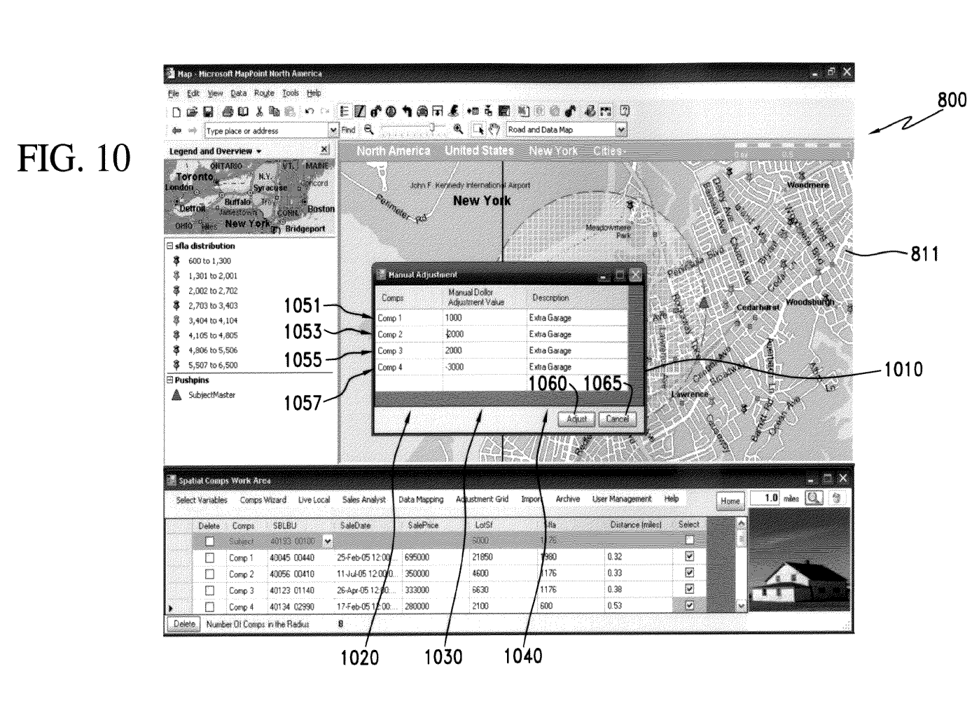

FIG. 10 is a screen shot of the screen 800 with the manual adjustment form 1010 overlaid over the zoomed-in view of a section 811 of the local area map 411, in accordance with at least one embodiment of the present invention. In FIG. 10, manual adjustment form 1010 may include, for example, but is not limited to, three columns, a comps column 1020, a manual dollar adjustment value 1030, and a description of the manual adjustment column 1040. The user manually enters one comp (i.e., property) per row, for example, as seen in FIG. 10, comp 1 is entered in row 1 1051, column 1 1020. A $1,000 adjustment value has been entered by the user in row 1 105 1, column 1030 for comp 1 and the description of what the adjustment is for has been entered in row 1 1051, column 1040. The user has repeated the process for comp 2 in the second row 1052, comp 3 in the third row 1053, and comp 4 in the fourth row 1054. An Adjust button 1060 may be positioned anywhere on manual adjustment form 1010 that space is available, and clicking on the Adjust button 1060 adds the manual adjustment information and pops-up a comparables Report. A Cancel button 1065 also may be positioned anywhere on the manual adjustment form 1010 that space is available, but, generally, it is located near the Adjust button 1060. Clicking on the Cancel button 1060 does not add the manual adjustment information, but still pops-up the comparables Report.

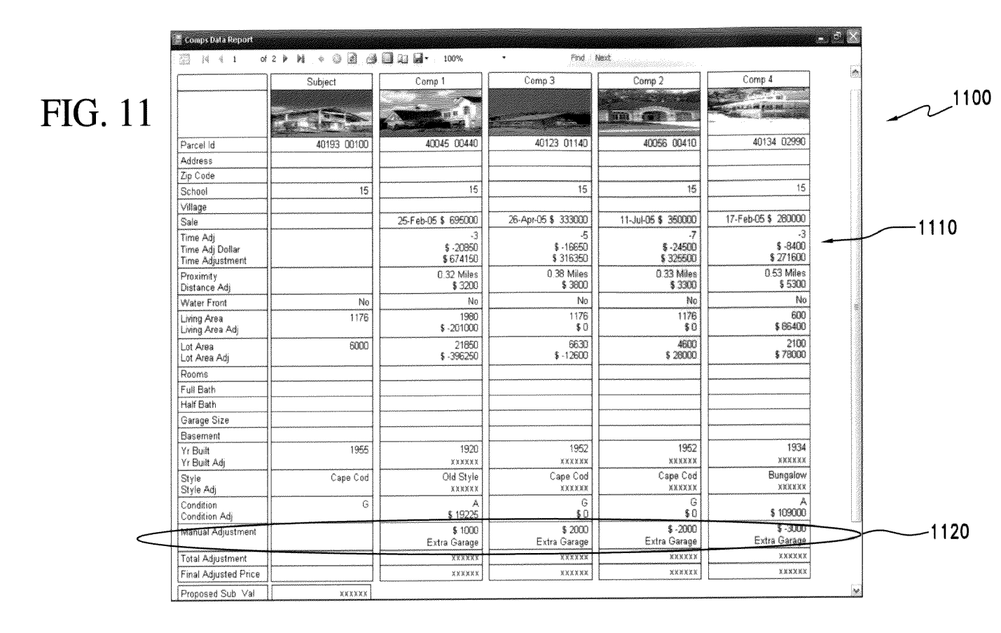

FIG. 11 is a screen shot 1100 of a comparables report 1110 with manual adjustment, in accordance with an embodiment of the present invention. In FIG. 11, the comparable report 1110 is generated with the best comps listed first. The report 1110 may be viewed in portrait or landscape formats and may be saved as PDF or Excel file formats. The report 1110 in FIG. 11 includes a manual adjustment row 1120 with the values entered into the manual adjustment form 1010. However, if the user does not need to make a manual adjustment, he/she may click on the Cancel button 1065 which in turn produces a report with out manual adjustment.

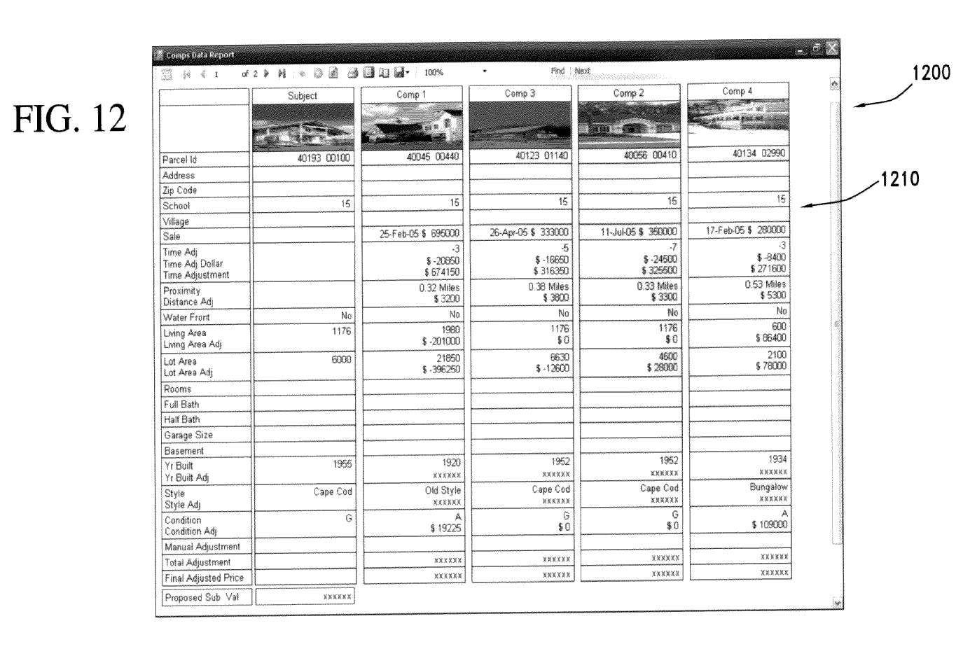

FIG. 12 is a screen shot 1200 of a comparables report 1210 without manual adjustment, in accordance with an embodiment of the present invention. In FIG. 11, the comparable report 1210 is generated with the best comps listed first.

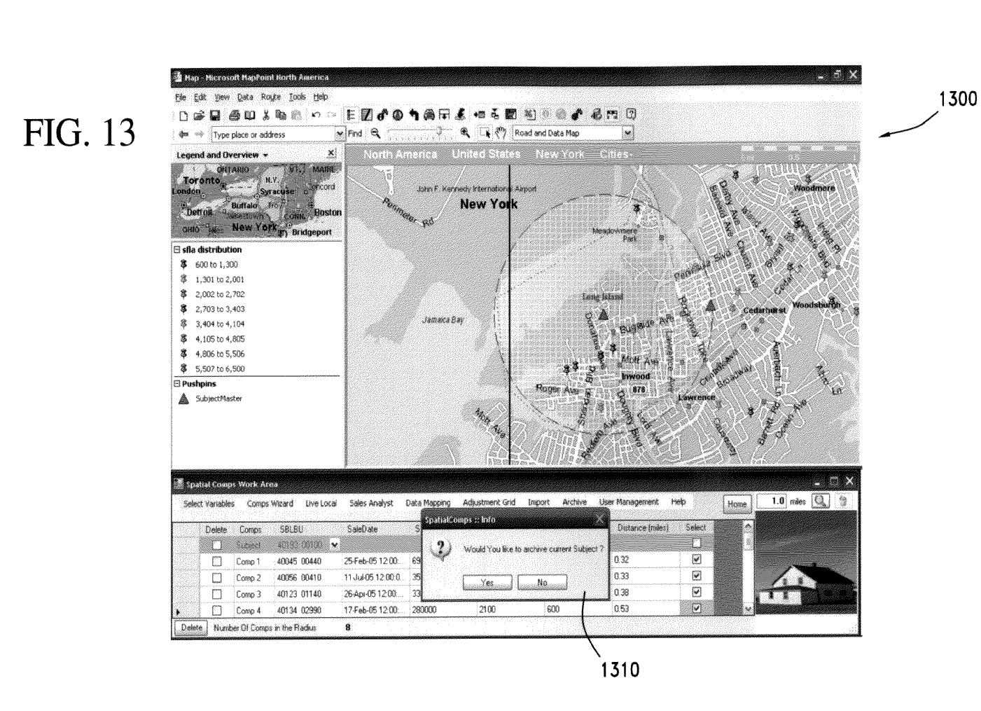

FIG. 13 is a screen shot of the screen 800 with an archive request window manual adjustment form 1310, in accordance with an embodiment of the present invention. After the report is closed application pops a message saying “Archive Subject”, if user selects “Yes” the selected subject will be saved in the database, which is then used by the administrator for archiving the subjects. If the user selects “No”, then the data will be “dumped” and will not be saved in the database.

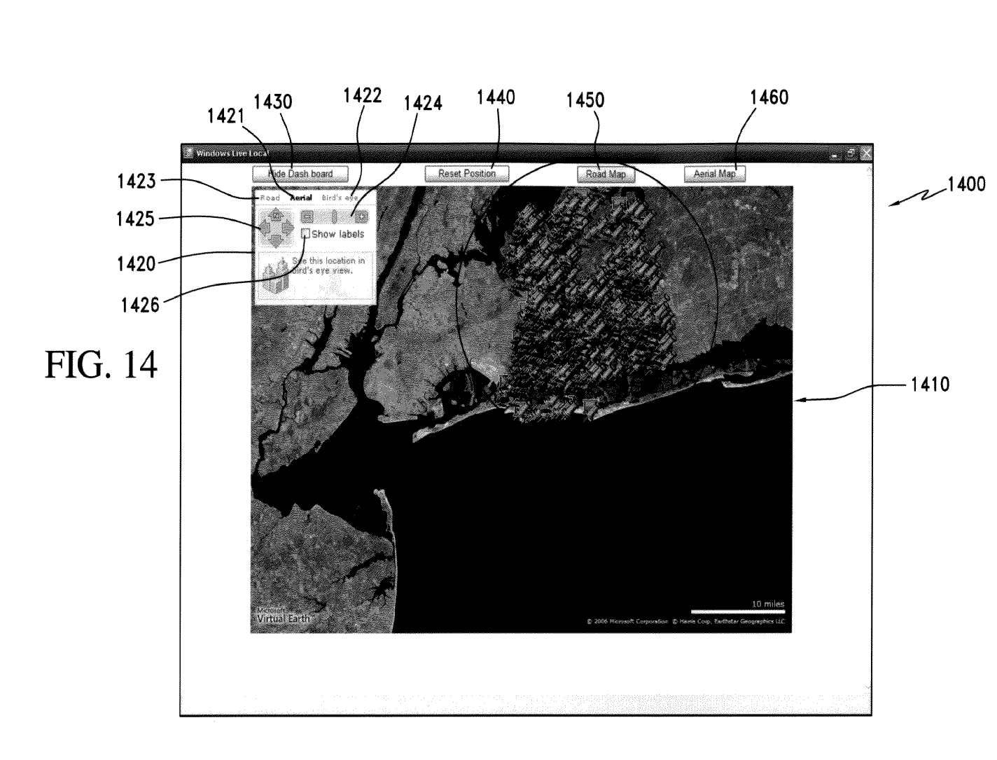

FIG. 14 is a screen shot of a screen 1400 of an aerial view of live local web page 1410, in accordance with an embodiment of the present invention. In FIG. 14, a dashboard control 1420 is shown to have an aerial menu option 1421, which is shown to be selected by being highlighted, a bird's eye view menu option 1422 to show close-up aerial photos of properties within the designated territory, and a road menu option 1423 to display a map with a road system overlay. In general, the live local web page 1410 only works when the system is connected to the Internet and works in two different ways. First, when a user doesn't select any comp and clicks on the Live Local option on the menu, it directly takes all the comps from the database and locates them on the live local user interface, which can be viewed in an aerial view or a bird's eye view. The dashboard control 1420 may also include a zoom control bar 1424 for zooming toward and away from the map, a directional control 1425 to enable the user to move the map in the north, south, east and west directions, and a show labels checkbox 1426 that, when checked, associates labels with elements in the map, for example, but not limited to, roads, places, and the like. The dashboard control 1420 may also include a bird's eye menu option 1422 to show a bird's eye view of the map.

In FIG. 14, the live local web page 1410 may include a hide dashboard button 1430, a reset position button 1440, a road map button 1450, and an aerial map button 1460.

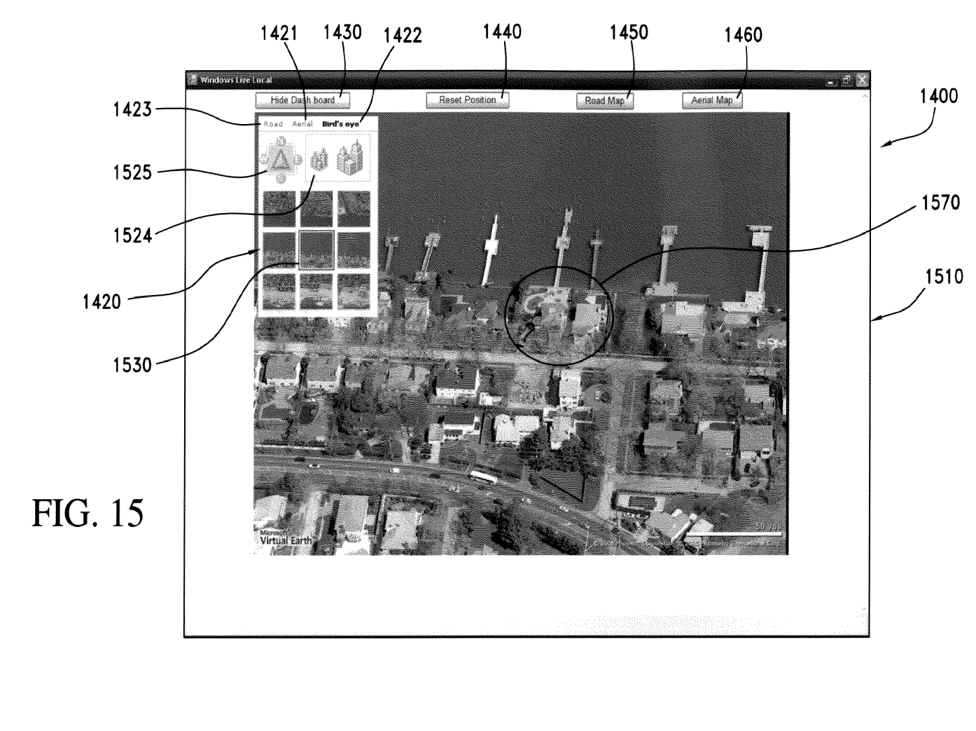

FIG. 15 is a screen shot of a screen 1500 of an aerial view of live local web page 1510, in accordance with an embodiment of the present invention. In FIG. 15, the bird's eye menu option 1422 is selected, as indicated by the bolded Bird's eye menu option 1422 in dashboard 1420. Dashboard 1420 now includes a directional control 1525 that may be slightly different in appearance, but not function, than directional control 1425 in FIG. 14. In FIG. 15, dashboard 1420 also includes a zoom control 1525 that may be slightly different in appearance, but not function, than zoom control bar 1425 in FIG. 14. In FIG. 15, a subject property 1570 is indicated by a push pin icon and further highlighted with a red circle.

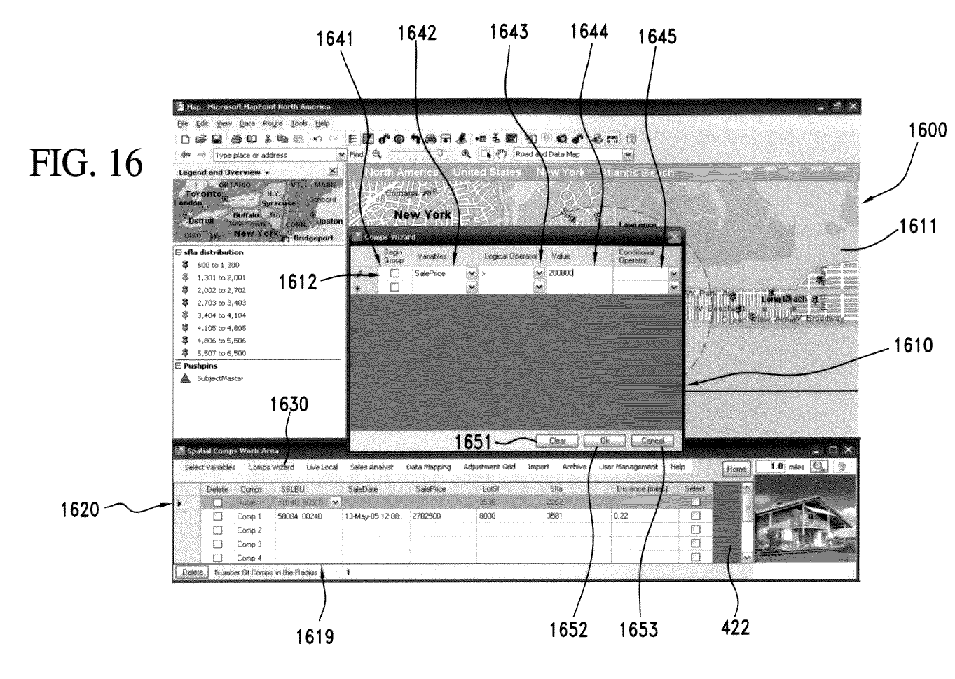

FIG. 16 is a screen shot of the screen 1600 with a comps wizard form 1610 overlaid over a local area map 1611, in accordance with at least one embodiment of the present invention. In FIG. 16, a comps wizard may be started after dragging and dropping a subject property into SBLBU column 1619 in a subject row 1620 of the grid area 422. The Comps Wizard button 1630 on the menu may be selected and the comps wizard form 1610 pops up over screen 1600 with the grid in which to write a query to search for additional comps. For example, in a first row 1612 in the comps wizard form 1610 information defining the search may be entered. In first row 1612, in a variables column 1642, a variable may be selected using a pull down menu associated with the variables column 1642 to select, for example, but not limited to, a SalePrice variable. The next column is a logical operator column 1643 and a logical operator may be selected using a pull down menu associated with the variables column 1642 to select, for example, but not limited to, a “>” (i.e., greater than) operator. In the next column, a value column 1644, a value may be entered, for example, $200, in order to retrieve only those comps with sales prices over $200,000. An optional conditional operator column 1645 may be selected from a drop-down menu to further limit the search results. For example, but not limited to, an if/then/else operator.

In FIG. 16, the comps wizard window 1610 may also include a clear button 1651 to clear the entries in first row 1612 and/or any other rows with entries in them, an OK button 1652 to accept the search logic and cause data to be fetched from the database using the given query, and a cancel button 1653 to cancel the sales analyst function and return to the screen 1600. This data may be filled into rows in the grid area 422 (also know as, the bucket) by calculating its respective distance from the subject.

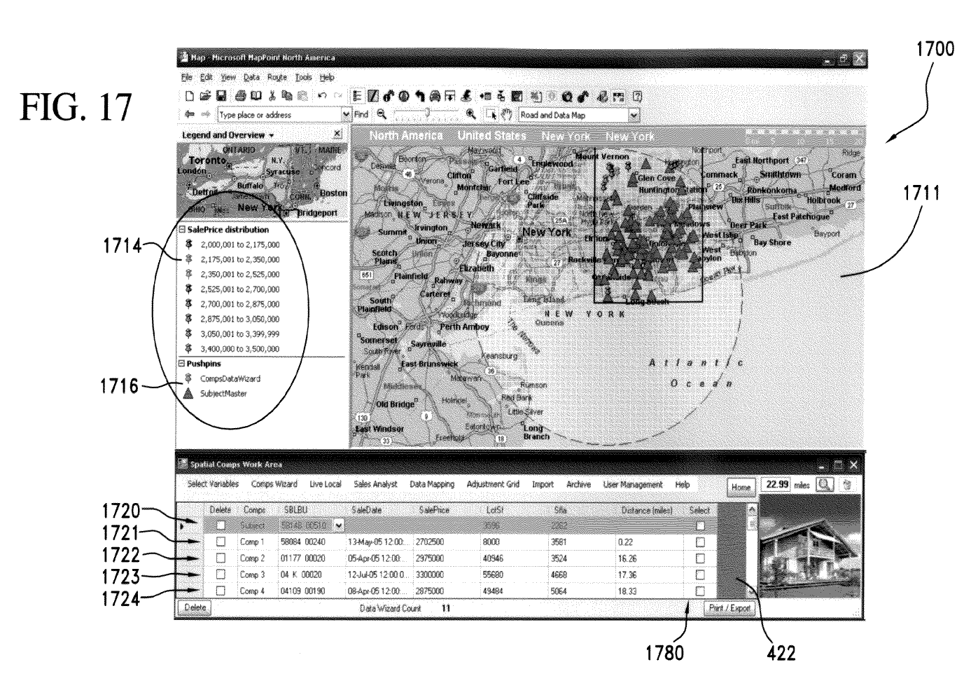

FIG. 17 is a screen shot of a screen 1700 of a local area map 1711 with subject properties having a sales price in according to the search criteria, in accordance with at least one embodiment of the present invention. In FIG. 17, eleven comps were located and added to the gird area 422 in rows 1721-1724 and beyond. A saleprice section 1714 may have replaced the sfla distribution 414 and a compsdatawizard pushpin 1716 has been added to of FIG. 4. The stratification on the left uses the first default value selected in the query. After the data is populated into the grid area 422, the user may check the select column 1780 in the grid area 422 for processing and generating the report.

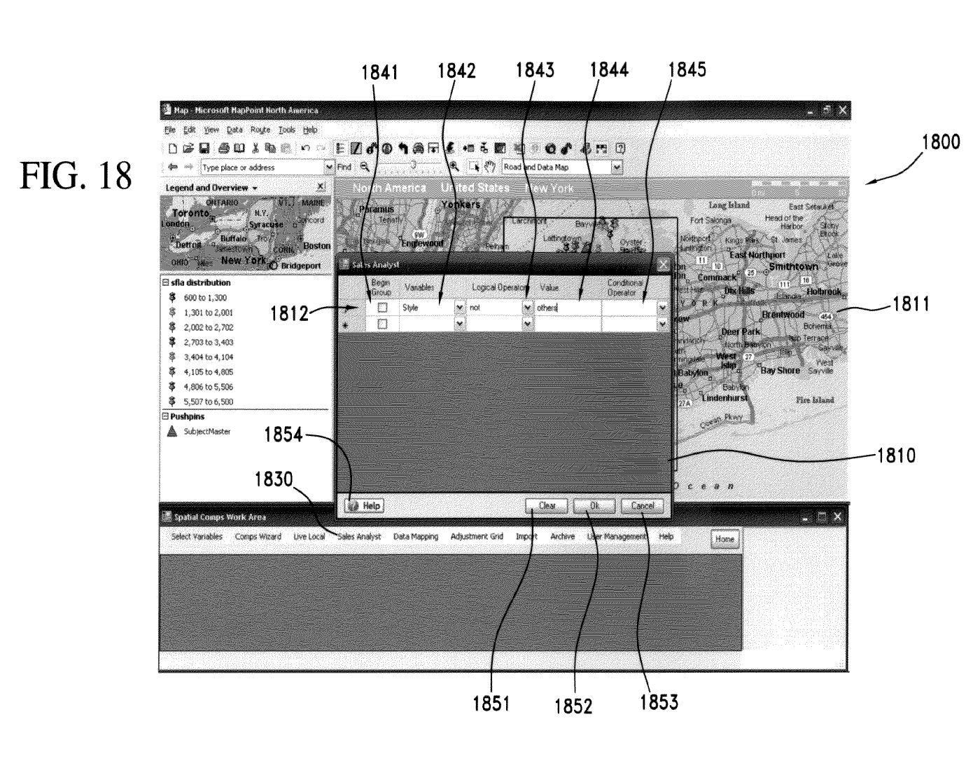

FIG. 18 is a screen shot of the screen 1800 with a sales analyst form 1810 overlaid over a local area map 1811, in accordance with at least one embodiment of the present invention. In FIG. 18, the sales analyst form 1810 is similar to the comps wizard query in FIG. 16 where the user applies the query and filters the data on the map itself. In FIG. 18, a sales analyst wizard may be started by selecting a sales analyst button 1830 on the menu and the sales analyst form 1810 pops up over screen 1800 with a grid in which to write a query to sort the comps. For example, in a first row 1812 in the sales analyst form 1810 information defining the search may be entered. In first row 1812, in a variables column 1842, a variable may be selected using a pull down menu associated with the variables column 1842 to select, for example, but not limited to, a Style variable. The next column is a logical operator column 1843 and a logical operator may be selected using a pull down menu associated with the variables column 1842 to select, for example, but not limited to, a Boolean “not” operator. In the next column, a value column 1844, a value may be entered, for example, “others”, in order to sort the comps by specific styles. An optional conditional operator column 1845 may be selected from a drop-down menu to further limit the search results. For example, but not limited to, an if/then/else operator.

In FIG. 18, the sales analyst form 1610 may also include a clear button 1851 to clear the entries in first row 1812 and/or any other rows with entries in them, an OK button 1852 to accept the search logic and cause data to be fetched from the database using the given query, a cancel button 1853 to cancel the sales analyst function and return to the screen 1800, and a help button 1854 to provide a link to a help service to answer the user's questions on how to use the sales analyst form 1810. This data may be filled into rows in the grid area 422 (also know as, the bucket) by calculating its respective distance from the subject.

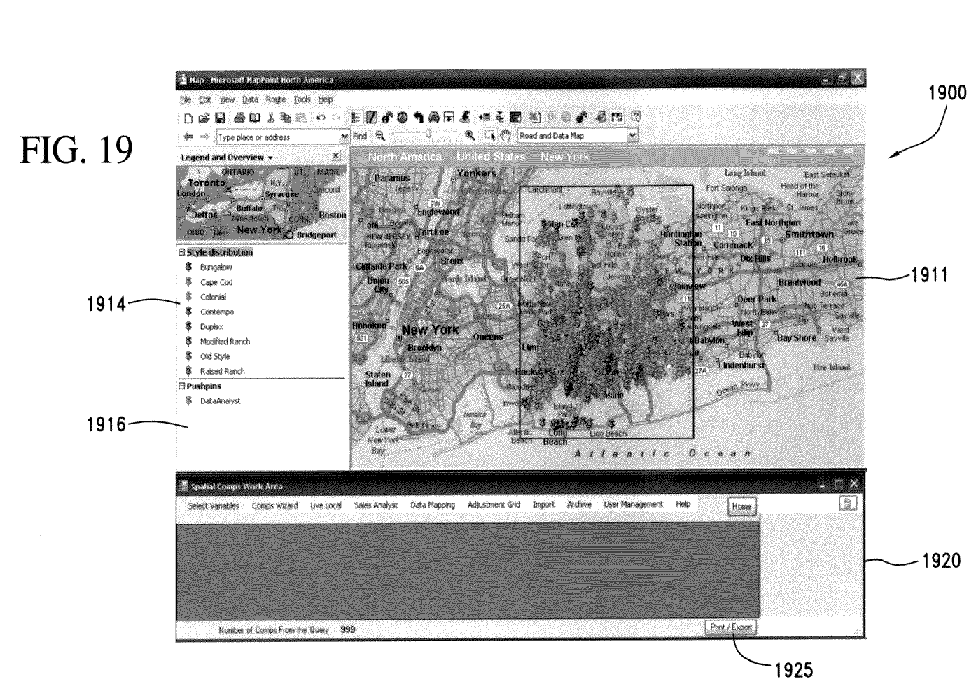

FIG. 19 is a screen shot of a screen 1900 of a local area map 1911 with subject properties having been sorted according to the style search criteria in FIG. 18, in accordance with at least one embodiment of the present invention. In FIG. 19, 999 comps were located, but, due to the large number located, they were not added to the gird area 422. However, a print/export button 1925 was added to a bottom screen 920 to enable the user to print out and/or export the comps data. A style distribution section 1914 may have replaced the sfla distribution 414 and a DataAnalyst pushpin 1916 has replaced the subject master triangle of FIG. 18. Filtered data is shown on the map with the territory. The user may click on any comp, and the system will draw a radius of the necessary distance to include the selected comp within the territory. Clicking on the Print/Export button on the work area enables the user to print or export the roadmap of the queried comps.

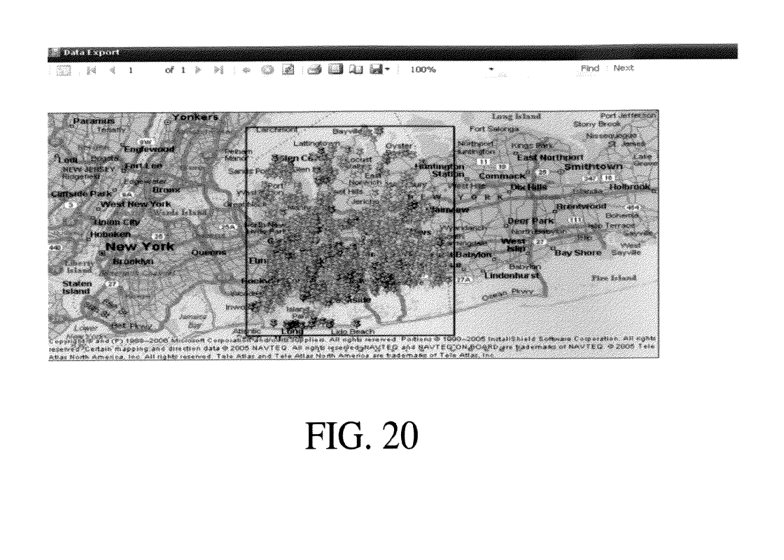

FIG. 20 is an example printout of the sorted map of FIG. 19, in accordance with an embodiment of the present invention.

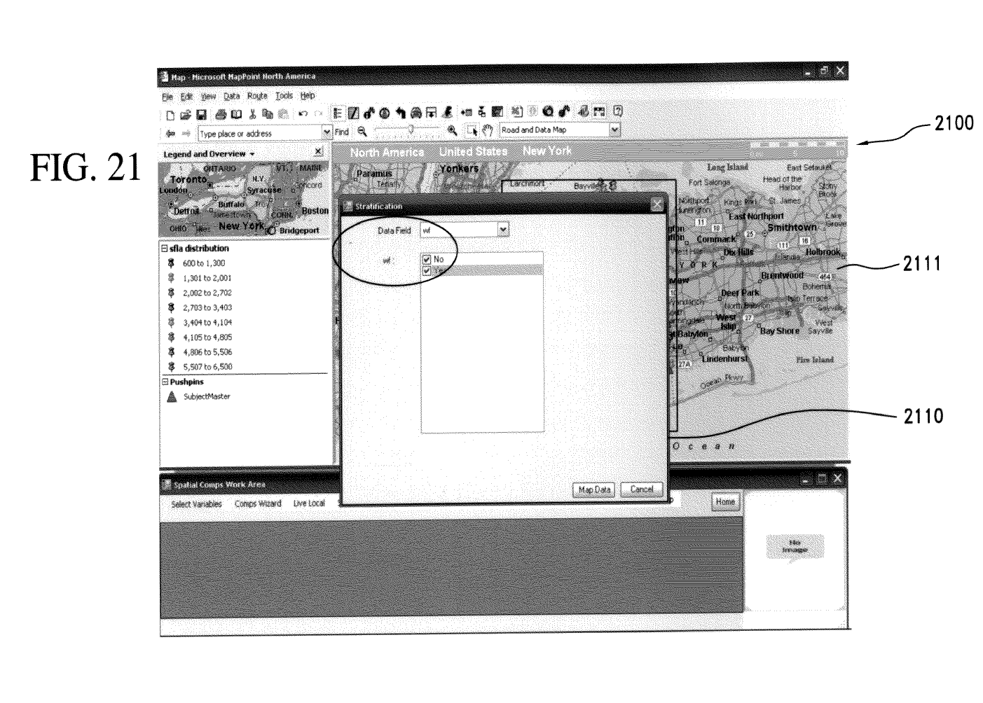

FIG. 21 is a screen shot of the screen 2100 with a stratification (i.e., data mapping) form 2110 overlaid over a local area map 2111, in accordance with at least one embodiment of the present invention. In FIG. 21, mapping the data on the basis of different attributes like “Sale Price, WF, Wcode, etc.,” the data may be mapped according to the user's choice as shown in FIG. 21.

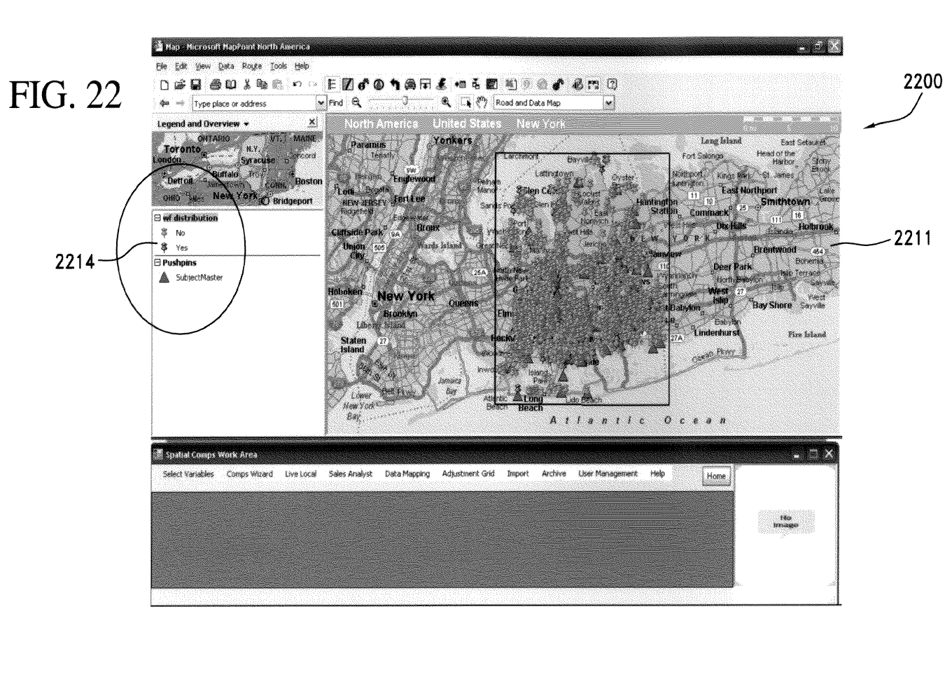

FIG. 22 is a screen shot of a screen 2200 of a local area map 2211 with subject properties having been sorted according to the WF search criteria specified in FIG. 21, in accordance with at least one embodiment of the present invention. In FIG. 22, no comps were located, but, due to the large number located, they were not added to the gird area 422. A wf distribution section 2214 may have replaced the sfla distribution 414. Filtered data is shown on the map with the territory. The user may click on any comp, and the system will draw a radius of the necessary distance to include the selected comp within the territory. Add and Remove buttons, which may be accessed by clicking on Data Mapping to display a new window where stratification can be added or removed for the selected data. It takes up to 16 ranges. Down left corner of the Stratification Form, Max and min values of the selected data field are displayed so that the user can key in the data range to lie between them. After mapping the data on the left side of the Microsoft Map Point, the user may check the stratification.

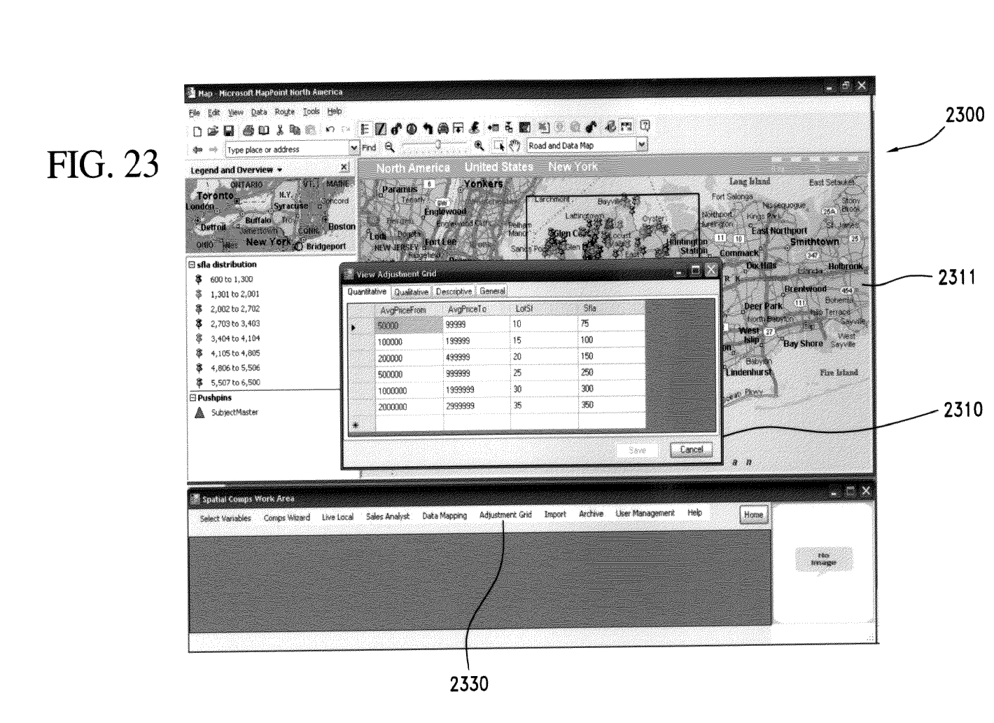

FIG. 23 is a screen shot of a screen 2300 with a view adjustment grid 2310 overlaid over a local area map 2311, in accordance with at least one embodiment of the present invention. In FIG. 23, the view adjustment grid 2310 appears after the user selects the Adjustment Grid button 2330 on the menu, with all the qualitative, quantitative and descriptive variables data. It is a read only grid.

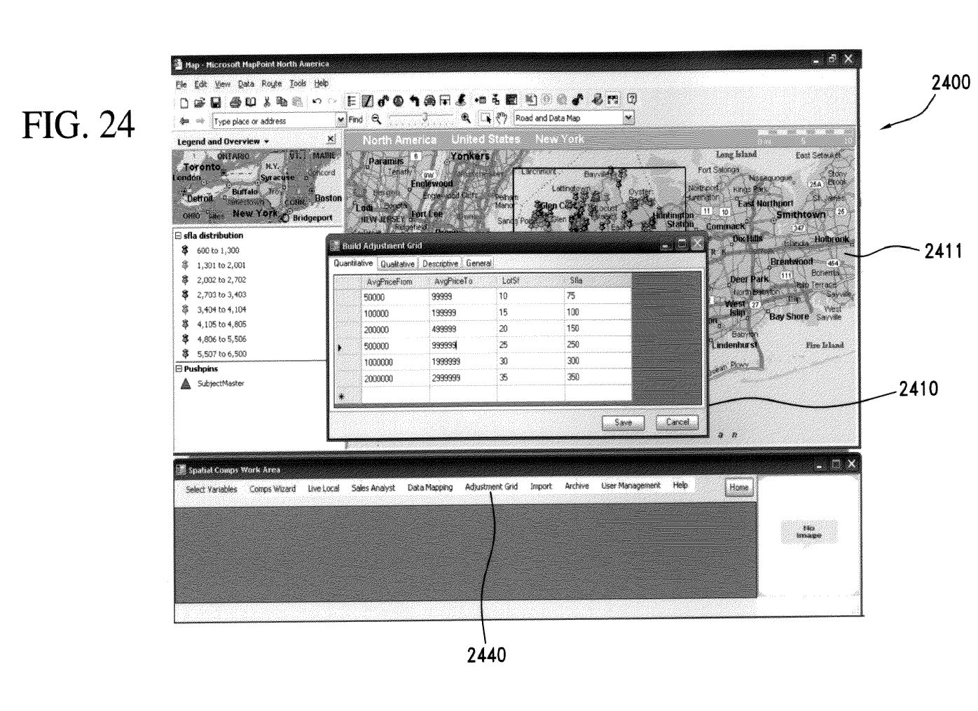

FIG. 24 is a screen shot of a screen 2400 with a build adjustment grid 2410 overlaid over a local area map 2411, in accordance with at least one embodiment of the present invention. In FIG. 24, the build adjustment grid 2410 appears after the user selects the Adjustment Grid button 2430 on the menu, with all the qualitative, quantitative and descriptive variables data. While any user may view these values via the view adjustment grid 2310 of FIG. 23, only a user with administrative rights can edit the build adjustment grid 2410 form.

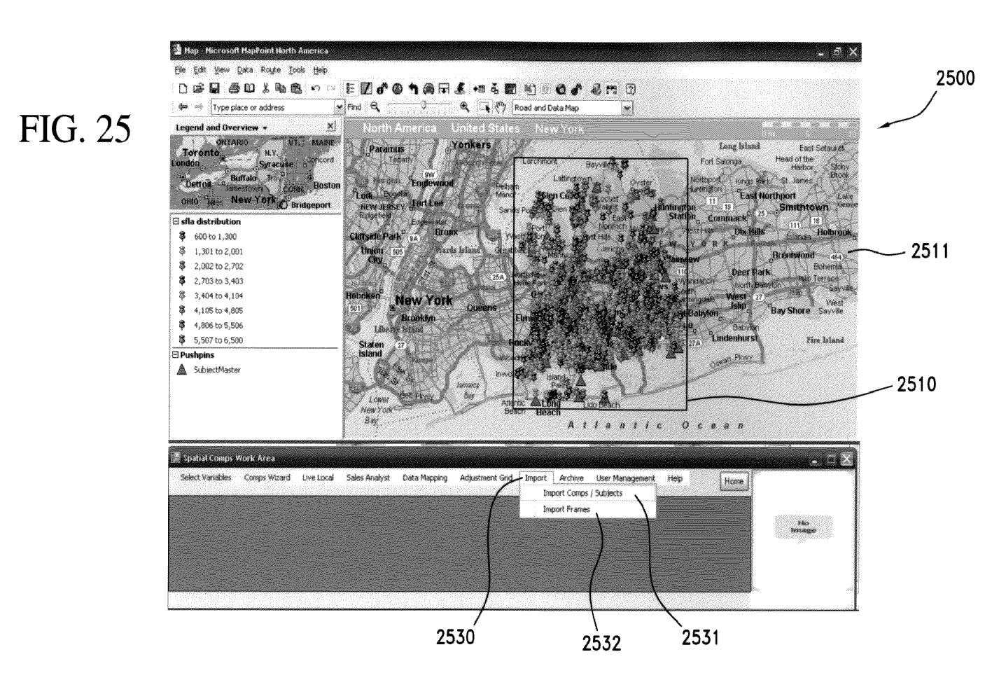

FIG. 25 is a screen shot of a screen 2500 of a local area map 2511 with subject properties in a territory 2510 having been identified according to the square footage of living area (sfla), in accordance with at least one embodiment of the present invention. In FIG. 25, only administrators have the right to perform this task of importing subject files, comps files and frames files into the database. In FIG. 25, an administrative user may select an import menu button 2530, which opens up two submenus of Import Comps/Subjects 2531 and Import Frames 2532.

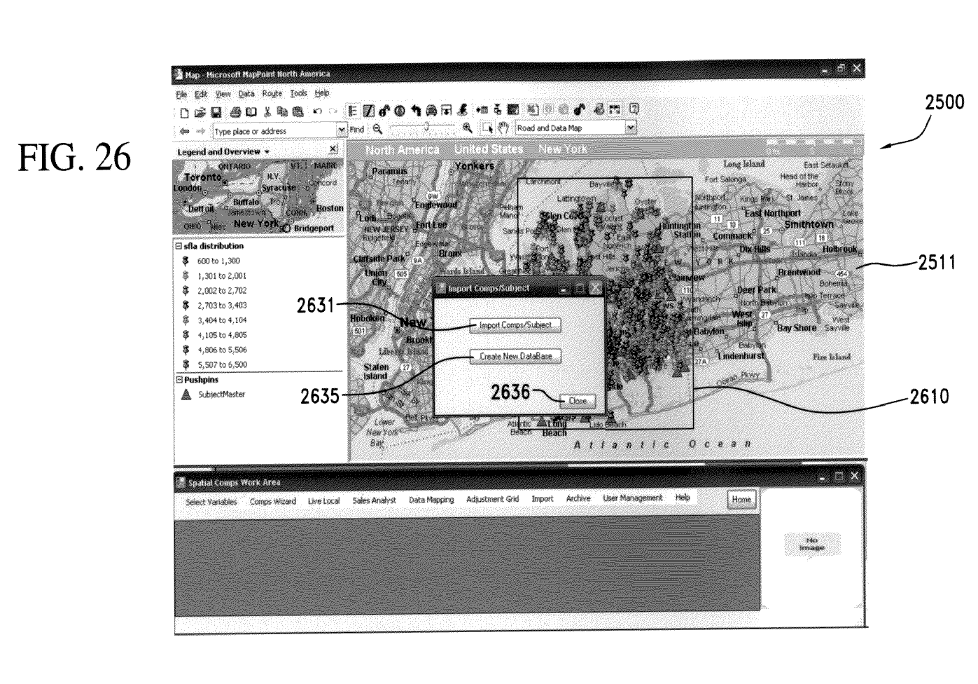

FIG. 26 is a screen shot of the screen 2500 of FIG. 25 with an import comps/subject window 2610 overlaid over the local area map 2511 of FIG. 25, in accordance with at least one embodiment of the present invention. In FIG. 26, the comps/subject window 2610 appears after the administrative user selects the Import Comps/Subjects 2531 submenu. The comps/subject window 2610 includes an Import Comps/Subjects button 2631, a Create New DataBase button 2635, and a Close button 2636. Selecting the Import Comps/Subject button 2631 imports the subject file, if earlier file is similar to the file being imported. Selecting the Create New DataBase button 2635 causes a new window to appear over top of the comps/subject window 2610.

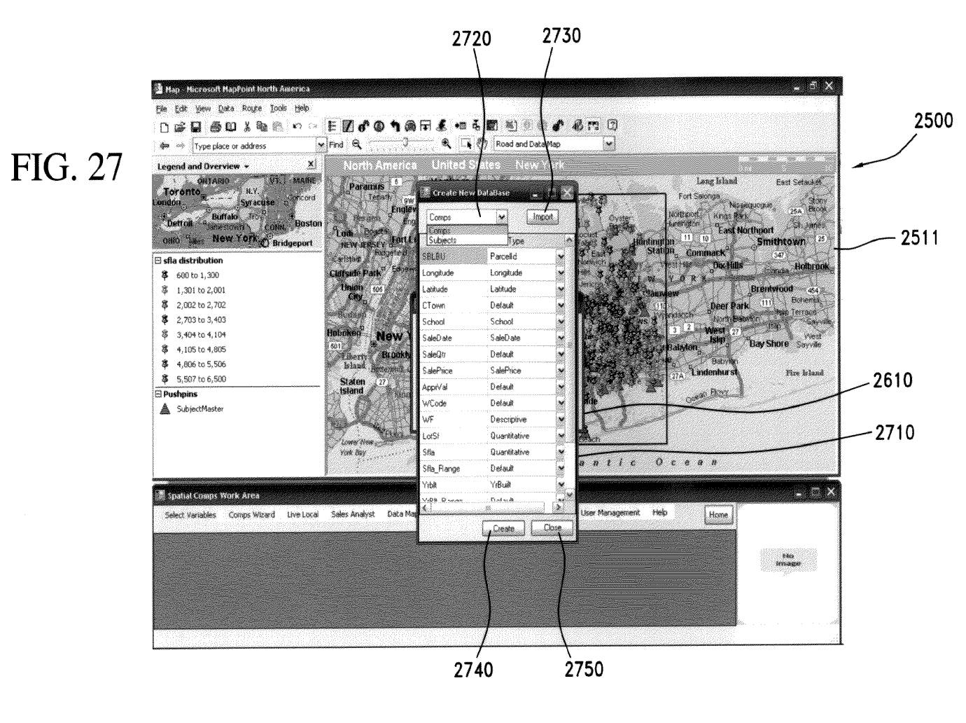

FIG. 27 is a screen shot of the screen 2500 of FIG. 26 with a Create New DataBase window 2710 overlaid over the import comps/subject window 2610 and the local area map 2511 of FIG. 26, in accordance with at least one embodiment of the present invention. In FIG. 27, the Create New DataBase window 2710 appears after the administrative user selects the Create New DataBase button 2635 in FIG. 26. In FIG. 27, the Create New DataBase window 2710 includes a Comps and Subjects pull-down menu 2720 to enable the user to select whether the new database is for comps or subjects, an Import button 2635 to import data, a Create button 2740 to create the new database, and a Close button 2750 to stop the creation of the new database. In addition to the above, the Create New DataBase window 2710 includes all of the variables and types that may contain data in the new database.

In FIG. 27, the administrator has to map the fields that are shown after importing the new data file, for example, an excel file. The mapping has to be done carefully, if not, the application will not support the calculations and there may be chance to introduce an error while working with the application. After the mapping is done, the system creates the new database and imports all the data into the local db. This is further used in the application. In general, the administrator has to map both the subject and comp files.

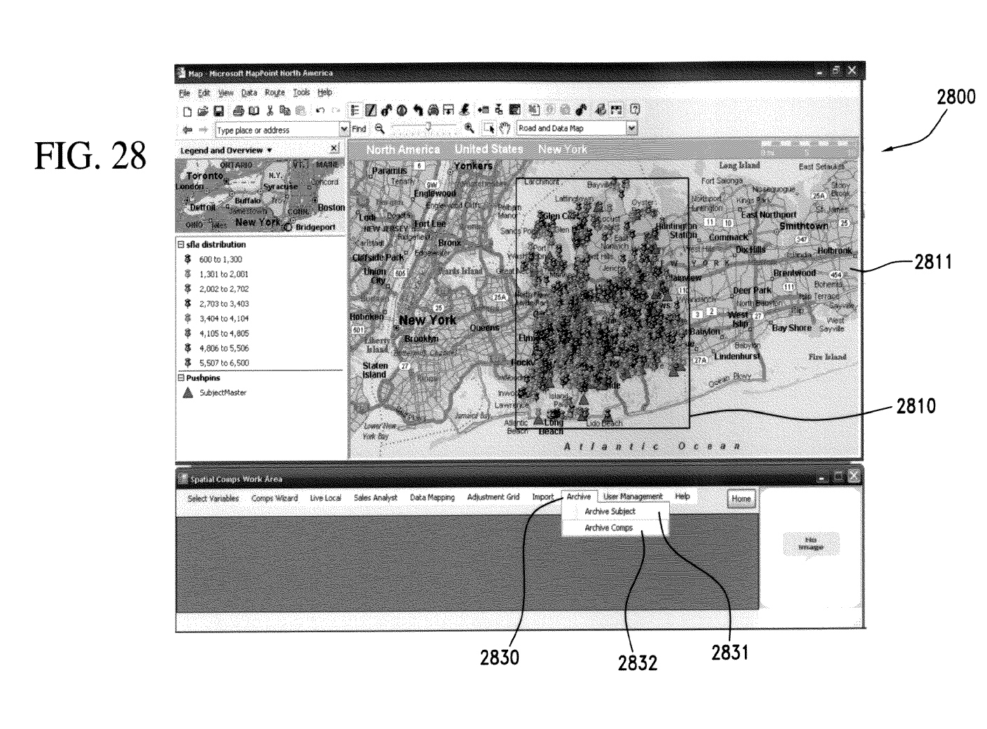

FIG. 28 is a screen shot of a screen 2800 of a local area map 2811 with subject properties in a territory 2810 having been identified according to the square footage of living area (sfla), in accordance with at least one embodiment of the present invention. In FIG. 28, only administrators have the right to perform the task of archiving subject files and comps files. In FIG. 28, an administrative user may select an archive menu button 2830, which opens up two submenus of Archive Subjects 2831 and Archive Comps 2832. In FIG. 28, selecting the Archive Subject submenu 2831 button provides a user interface for archiving the subjects which are stored at the time of report generation. Similarly, selecting the Archive Comps submenu 2832 button provides a user interface for archiving the comps which are stored at the time of report generation.

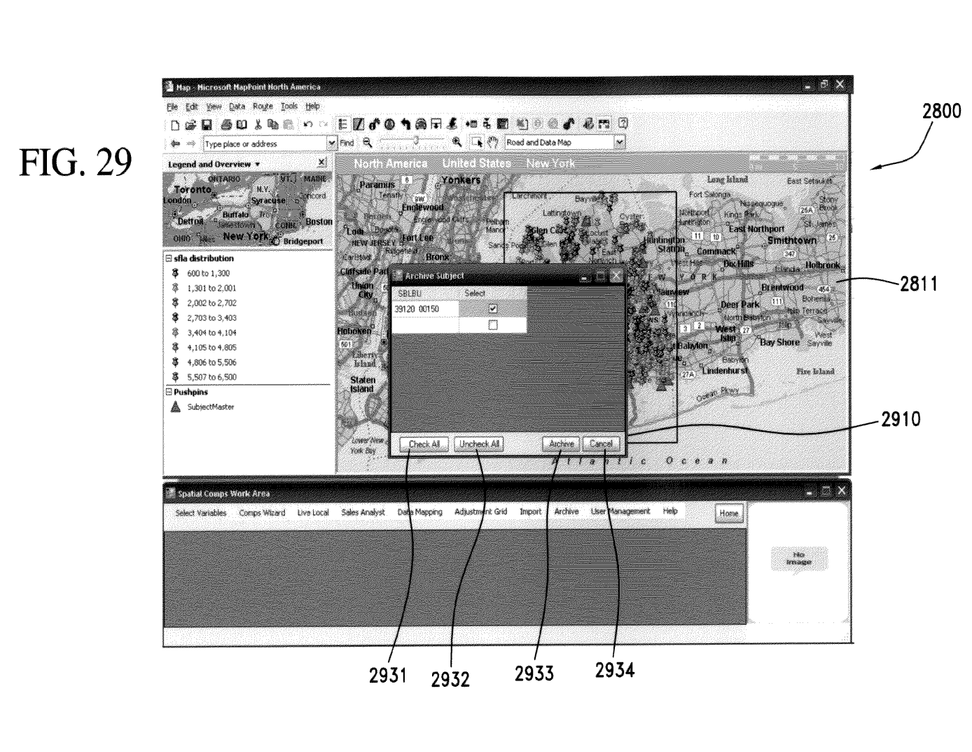

FIG. 29 is a screen shot of the screen 2800 of FIG. 28 with an archive subject window 2910 overlaid over the local area map 2811 of FIG. 28, in accordance with at least one embodiment of the present invention. In FIG. 29, the archive subject window 2910 appears after the administrative user selects the archive subject submenu 2531. The archive subject window 2910 includes a listing of available subjects to be archived along with a select check box for ease of selection of the subjects to be archived. The archive subject window 2910 may also include a Check All button 2931 to select all available subjects in the list, an Uncheck All button 2932 to deselect all available checked subjects in the list, an Archive button 2933 to archive the selected comps, and a Cancel button 2934 to stop the archiving process.

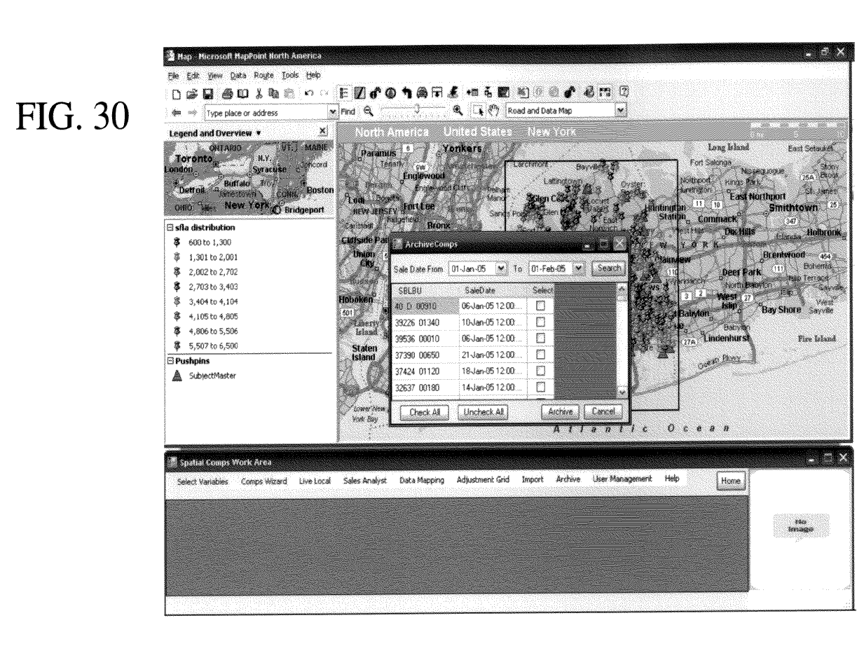

FIG. 30 is a screen shot of the screen 2800 of FIG. 28 with an archive comps window 3010 overlaid over the local area map 2811 of FIG. 28, in accordance with at least one embodiment of the present invention. In FIG. 30, the archive comps window 3010 appears after the administrative user selects the archive comps submenu 2832. The archive comps window 3010 includes a listing of available subjects to be archived along with a select check box for ease of selection of the subjects to be archived. The archive comps window 3010 may also include a Check All button 3031 to select all available comps in the list, an Uncheck All button 3032 to deselect all available checked comps in the list, an Archive button 3033 to archive the selected comps, and a Cancel button 3034 to stop the archiving process.

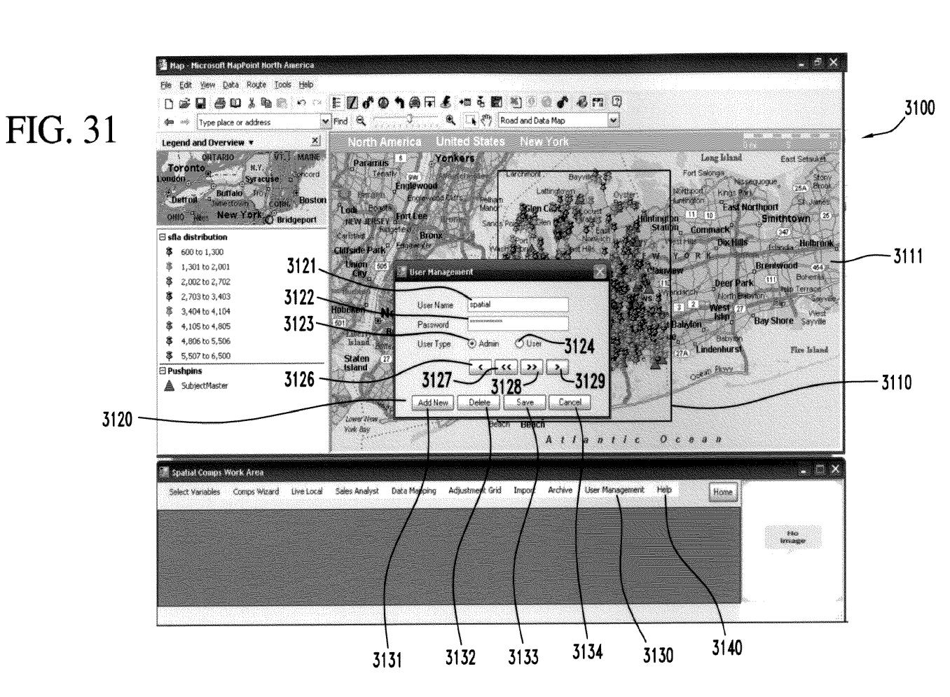

FIG. 31 is a screen shot of a screen 3100 with a local area map 3111 with subject properties in a territory 31 1 0 having been identified according to the square footage of living area (sfla), in accordance with at least one embodiment of the present invention. In FIG. 31, a user management window 3120 appears after the administrative user selects the User Management button 3130 from the menu. This option enables the administrators to create and manage users and their permissions. The user management window 3120 includes a user name entry box 3121, a password entry box 3122, an admin type checkbox 3123, a user checkbox 3124, a move one user record to the left button 3126, a move to the leftmost user record button 3127, a move to the rightmost user record button 3128, and a move one user record to the right button 3129. The user management window 3120 may also include an Add New button 3131 to add a new user record, a delete button 3132 to delete an existing user record, a save button 3133 to save the user records, and a cancel button 3134 to stop the user management session.

In FIG. 31, if a user clicks on a Help button 3140, a User Guide and system details are displayed.

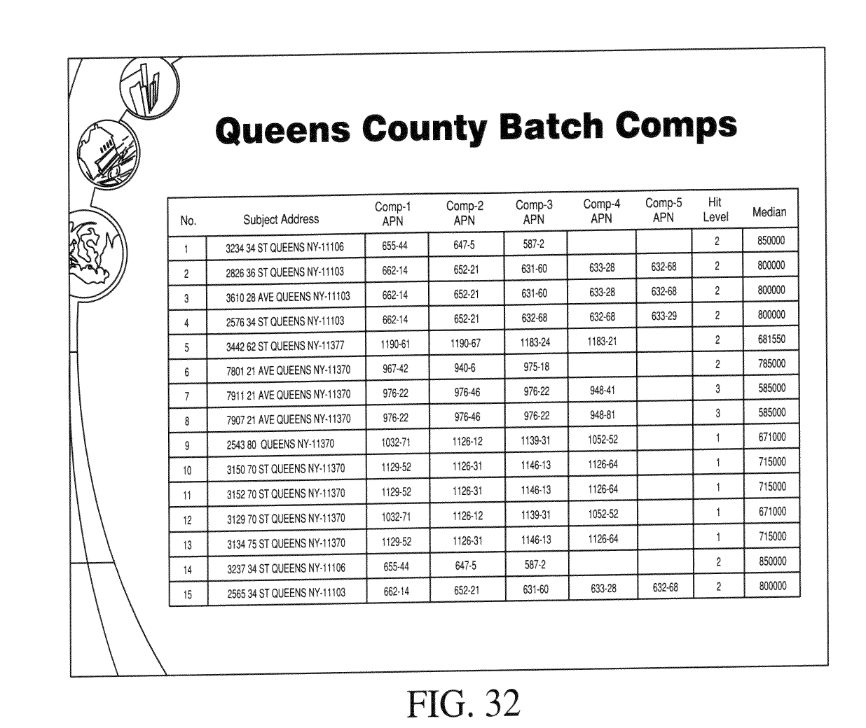

FIG. 32 is a sample of a summary of batch comps results for a number of subject properties, in accordance with at least one embodiment of the present invention. In FIG. 32, summary valuation results for a batch of fifteen different subject properties with up to five comps per subject property, a measure of a hit level, and a median valuation value are provided. Hit level is also referred to as confidence level and is a measure of how similar a comparable property is to the subject property. For example, a hit level of 1, which equates to a high confidence level, would result from the use of a comparable property that is the same model, built by the same builder, next door to, in the same year as, with the same square footage of living area and lot size as, the same floor plan as, the same number of rooms as, etc. the subject property. In general, for embodiments of the present invention to be able to calculate a batch comp valuation of a subject property, at least three comparable properties must be identified for the subject property and have a hit level of 1 or 2. Likewise, for a hit level of 3, generally, at least four comparable properties must be identified.

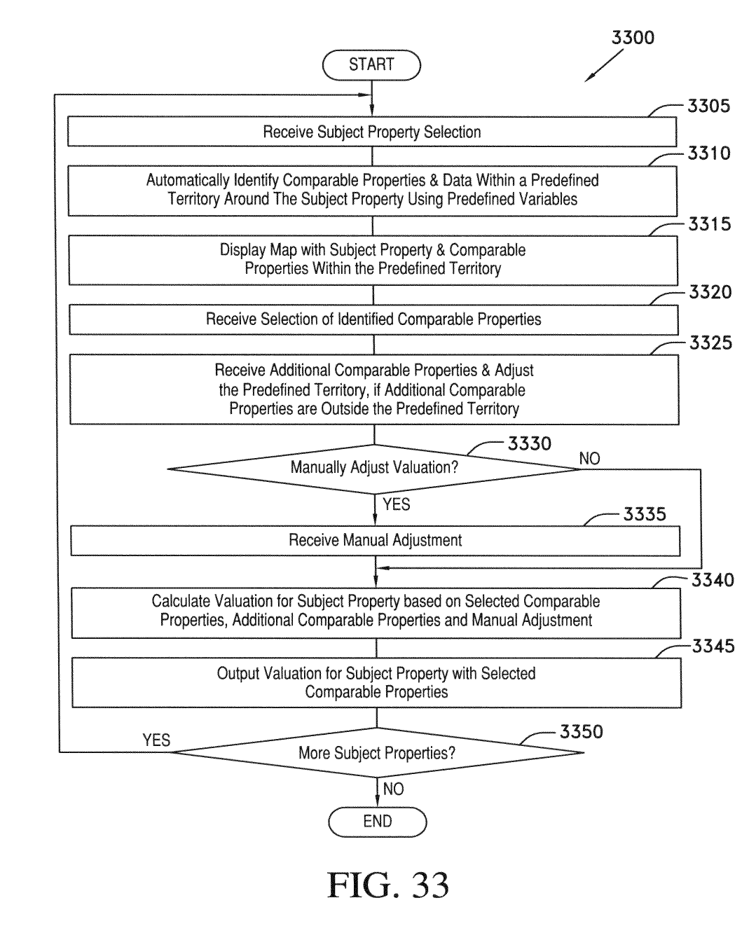

FIG. 33 is a flowchart of a method of providing spatially-oriented real estate valuations, in accordance with an embodiment of the present invention. In FIG. 33, the method may start by receiving (3305) a selection of a subject property for which a valuation is desired. The method may then automatically identify (3310) comparable properties and their associated data that are located within a predefined territory around the subject property using predefined variables. The locations of the subject property and comparable properties may be displayed (3315) on a map within the predefined territory. In general, the territory is indicated by a circle around the subject property, which is located at the center of the circle, with a constant radius, as seen, for example, in FIGS. 8, 9 and 17. In FIG. 33, the method may receive (3320) a selection of the identified comparable properties to be used in preparing the valuation of the subject property and the map may be updated to now only display the selected comparable properties. In addition, the method may receive (3325) one or more additional comparable properties that were not part of the original automatically identified (3310) comparable properties and adjust the size of the predefined territory to include the one or more additional comparable properties, if the one or more additional comparable properties are outside the predefined territory. For example, if the original predefined territory was limited to a one-mile radius around the subject property, but the most distant one of the one or more additional comparable properties was two-miles away from the subject property, the predefined territory would be redrawn with a two-mile radius and the map would be updated to display the selected comparable properties and the one or more additional comparable properties.

In FIG. 33, the method may determine (3330) whether any manual adjustments to the valuation are to be made. If it is determined (3330) that at least one manual adjustment is to be made, the method receives (3335) the at least one manual adjustment and saves it for use in calculating the valuation. For example, as seen in FIG. 10, manual dollar adjustments (both positive and negative) are shown being entered for the four comparable properties (i.e., Comp 1, Comp 2, Comp 3, and Comp 4). If it is determined (3330) that no manual adjustment is to be made or after a manual adjustment is received (3335), the method may continue and calculate (3340) a valuation for the subject property based on the selected comparable properties, the additional comparable properties and the manual adjustment. The method may then output (3345) the valuation with details for the subject property and the selected comparable properties, the additional comparable properties and the manual adjustment, as seen in FIG. 11 and without the manual adjustment, as seen in FIG. 12. The outputting (3345) of the valuation may include displaying the valuation on the screen, printing the valuation, as well as saving the valuation for future use and/or reference. The method may determine (3350) whether there are more subject properties for which to calculate valuations. If it is determined (3350) that there are more subject properties, the method may loop back and receive (3305) another subject property and continue as described above. However, if it is determined (3350) that there are not any more subject properties, the method may end.

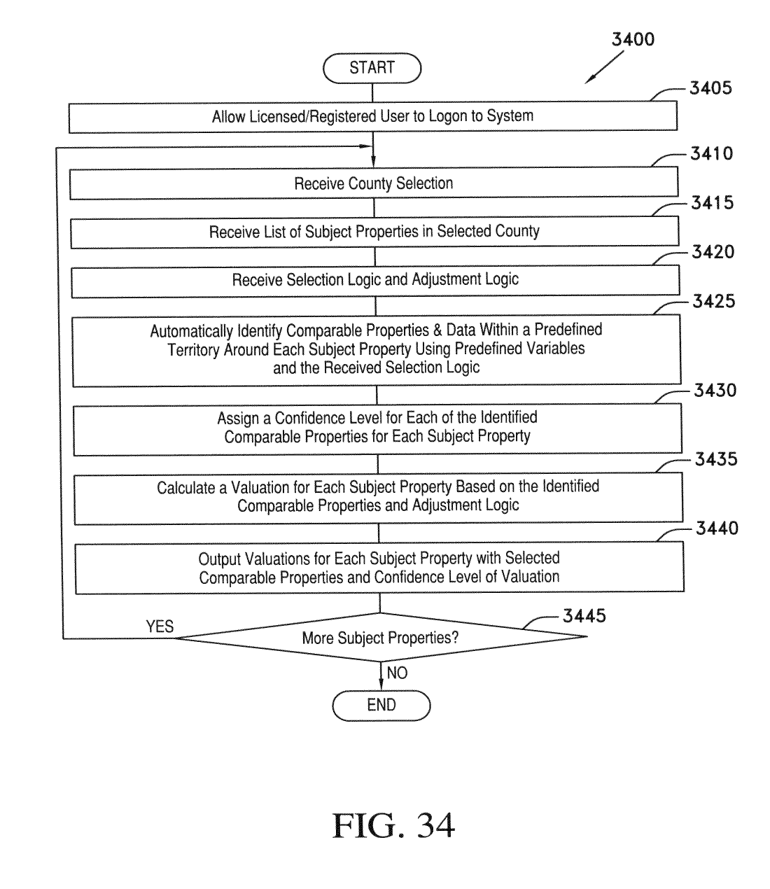

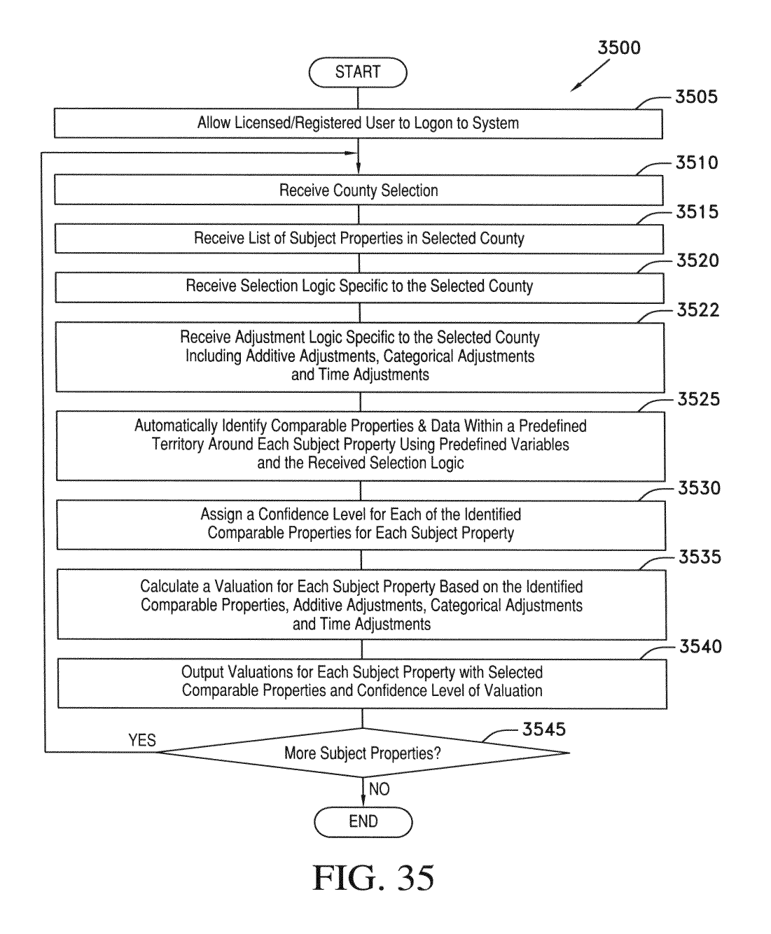

Although the above description appears to imply a specific order in how the method in FIG. 33 is performed, it is contemplated that some, if not all, of the elements of the method may be performed simultaneously and/or in an order different than described above without affecting the validity and/or accuracy of the valuation. The same is also true for the methods described below in relation to FIGS. 34 and 35.

FIG. 34 is a flowchart of a method of providing spatially-oriented batch comparable real estate valuations, in accordance with an embodiment of the present invention. In FIG. 34, the method may start by receiving a logon request from a user, verifying that the user is a licensed and/or registered user, and allowing (3405) the licensed and/or registered user to have access to the method. The method may receive (3410) a selection of a county in a state in which a list of subject properties are located. The method may then receive (3415) the list of subject properties in the selected county for which valuations are to be calculated. Although in the presently described embodiment of the present invention the method is receiving the listing of subject properties grouped by county, which is expected to be the most likely scenario for use, it is also contemplated that embodiments of the method will be able to receive a listing of subject properties located in more than one county and still be able to calculate valuations for each of the subject properties. In these alternative embodiments, the receiving (3415) of the single county selection will not occur and each property will include an identification of the county and state in which it is located.

In FIG. 34, the method may receive (3420) selection logic to be used to determine which comparable properties will be selected for use in the valuation and adjustment logic to be used to adjust one or more of the comparable properties when determining the valuation of the subject property. The method may then automatically identify (3425) comparable properties and their associated data within a predefined territory around each of the subject properties using predefined variables and the received selection logic. The method may assign (3430) a confidence level to each of the identified comparable properties for each subject property. The confidence level may be based on a hit level determination of how close each comparable property was to the subject property. For example, if the subject property had 1500 square feet of living area and was on a lot that had 8,000 square feet, a first comparable property had 1550 square feet of living area and was on a lot that had 7,900 square feet, an allowable living area size variation of plus or minus 5% (i.e., ±75 square feet) and an allowable lot size variation of plus or minus 10% (i.e., ±800 square feet), the first comparable property would result in a high confidence value for the valuation, since the actual allowable living area difference of 50 square feet is less than the allowed 75 square feet and the actual lot size variation of 100 square feet is less than the allowed 800 square feet.

In FIG. 34, the method may continue and calculate (3435) a valuation for each of the subject properties based on the selected comparable properties for each subject property and the adjustment logic. The method may then output (3440) the valuations for each of the subject properties and the selected comparable properties used for the valuation, as seen in FIG. 32. Returning to FIG. 34, the outputting (3440) of the valuation may include displaying the valuation on the screen, printing the valuation, as well as saving the valuation for future use and/or reference. The method may determine (3445) whether there are more subject properties for which to calculate valuations. If it is determined (3445) that there are more subject properties, the method may loop back and receive (3410) another county selection and continue as described above. However, if it is determined (3450) that there are not any more subject properties, the method may end.

FIG. 35 is a flowchart of a yet another method of providing spatially-oriented batch comparable real estate valuations, in accordance with an alternative embodiment of the present invention. In FIG. 35, the method may start by receiving a logon request from a user, verifying that the user is a licensed and/or registered user, and allowing (3505) the licensed and/or registered user to have access to the method. The method may receive (3510) a selection of a county in a state in which a list of subject properties are located. The method may then receive (3515) the list of subject properties in the selected county for which valuations are to be calculated. Although in the presently described embodiment of the present invention the method is receiving the listing of subject properties grouped by county, which is expected to be the most likely scenario for use, it is also contemplated that embodiments of the method will be able to receive a listing of subject properties located in more than one county and still be able to calculate valuations for each of the subject properties. In these alternative embodiments, the receiving (3515) of the single county selection will not occur and each property will include an identification of the county and state in which it is located.

In FIG. 35, the method may receive (3520) selection logic to be used to determine which comparable properties will be selected for use in the valuation of the subject property. The method may also receive (3522) adjustment logic specific to the selected county to be used to adjust one or more of the comparable properties when determining the valuation. For example, the adjustment logic may include additive adjustments, which increase or decrease the value assigned to specific features of a comparable property; categorical adjustments, which increase or decrease the value assigned to condition, style etc. of a comparable property location adjustment, which increase or decrease the value assigned to the subject location; and time adjustments, which increase or decrease the value assigned to the sales price of the comparable property depending how long ago the comparable property sold and the current market conditions. The method may then automatically identify (3525) comparable properties and their associated data within a predefined territory around each of the subject properties using predefined variables and the received selection logic. The method may assign (3530) a confidence level to each of the identified comparable properties for each subject property. The confidence level may be based on a hit level determination of how close each comparable property was to the subject property. For example, if the subject property had 1500 square feet of living area and was on a lot that had 8,000 square feet, a first comparable property had 1550 square feet of living area and was on a lot that had 7,900 square feet, an allowable living area size variation of plus or minus 5% (i.e., ±75 square feet) and an allowable lot size variation of plus or minus 10% (i.e., ±800 square feet), the first comparable property would result in a high confidence value for the valuation, since the actual allowable living area difference of 50 square feet is less than the allowed 75 square feet and the actual lot size variation of 100 square feet is less than the allowed 800 square feet.

In FIG. 35, the method may continue and calculate (3535) a valuation for each of the subject properties based on the selected comparable properties for each subject property and the adjustment logic, including additive adjustments, categorical adjustments, and time adjustments. The method may then output (3540) the valuations for each of the subject properties and the selected comparable properties used for the valuation, as seen in FIG. 32. Returning to FIG. 35, the outputting (3540) of the valuation may include displaying the valuation on the screen, printing the valuation, as well as saving the valuation for future use and/or reference. The method may determine (3545) whether there are more subject properties for which to calculate valuations. If it is determined (3545) that there are more subject properties, the method may loop back and receive (3510) another county selection and continue as described above. However, if it is determined (3550) that there are not any more subject properties, the method may end.

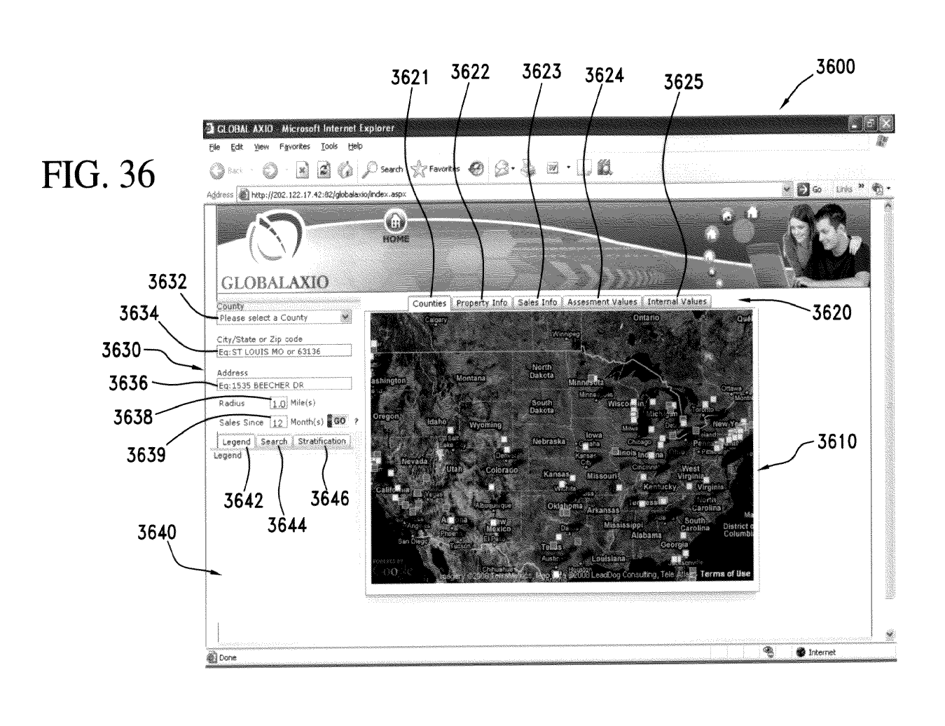

FIG. 36 is a screen shot of a web page of a system for providing home valuations showing available counties in which information is available to calculate a home valuation, in accordance with an alternative embodiment of the present invention. In FIG. 36, a screen 3600 includes a map portion 3610, which is displaying a map of the continental United States with yellow or orange highlighted icons indicating the counties in which the system has home sale information to be used to calculate home valuations. Map portion 3610 has a row of five tabs 3620 immediately above it that control what is displayed in the map portion 3610. These tabs include a Counties tab 3621 to show the counties in which sales data is available, a Property Info tab 3622 for displaying information about the subject property, a Sales Info tab 3623 for providing sales information about the subject property, an Assessment Values tab 3634 for providing assessed value information about the subject property, and an Internal Values tab 3635 for providing information on the house, comparable properties, and AVM value.

In FIG. 36, the screen 3600 also includes a user input section 3630 in which a user must first select a county in a menu selection window 3632, then city and state or Zip code in a City/State or Zip box 3634, and then a street address for the subject property in and address box 3636. Other inputs may include a radius box 3638 to receive a radius value to control the area around the subject property in which comparable properties are to be located, and a sales since box 3639 to receive a number of months to extend backwards to look for sales of comparable properties. Screen 3600 further includes a comparables information section 3640, which provides information on the comparable properties that are selected based on the selection criteria. Comparables information section 3640 also includes three tabs, a legend tab 3642 that is used to provide map legend information after a search has been performed. The information section 3640 may also include a search tab 3644 to provide for an advanced search option by being able to specify additional search criteria. For example, but not limited to, a range for the building square feet, a range for the year built, and the like. The information section 3640 may further include a stratification tab 3646 to manually enter levels at which to stratify the located comparable properties, for example, but not limited to, ranges of sales prices, ranges of building square feet, and the like.

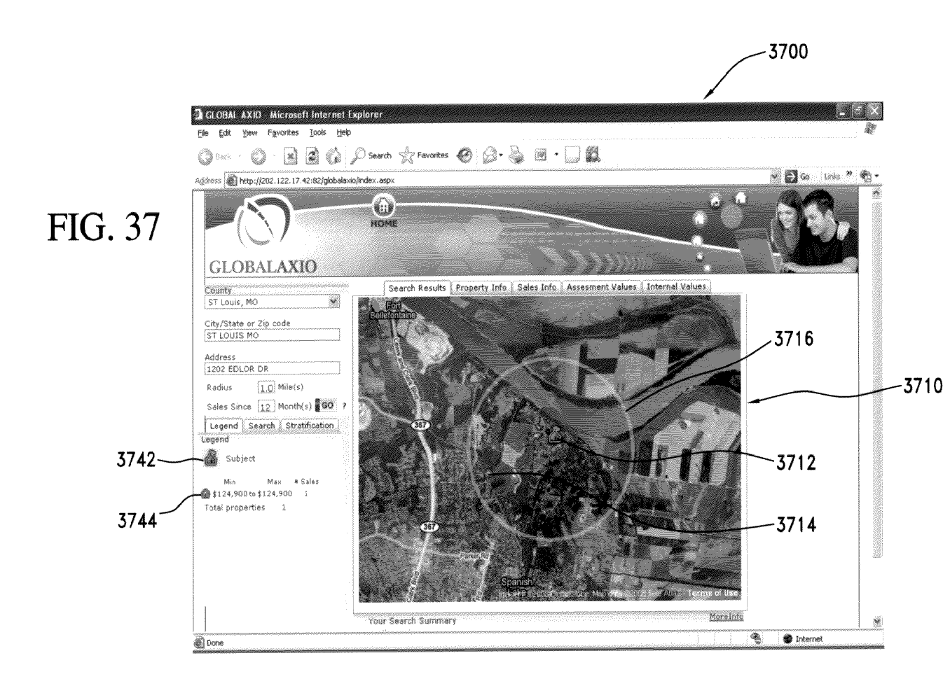

FIG. 37 is a screen shot of a web page display of results from a search on a subject property using the system, in accordance with an alternative embodiment of the present invention. In FIG. 37, a screen 3700 is displaying a partially zoomed-in view of a map 3710 over St. Louis, Mo., with a subject property 3712 and a single comparable property 3714 within a one-mile radius territory defined by a circle 3716 around subject property 3712. Information section 3640 has been updated to show a subject property icon 3742 and a comparable property icon 3744 with minimum and maximum sales values for the comparable property. In this example, only one comparable property was located that fit the selection criteria.

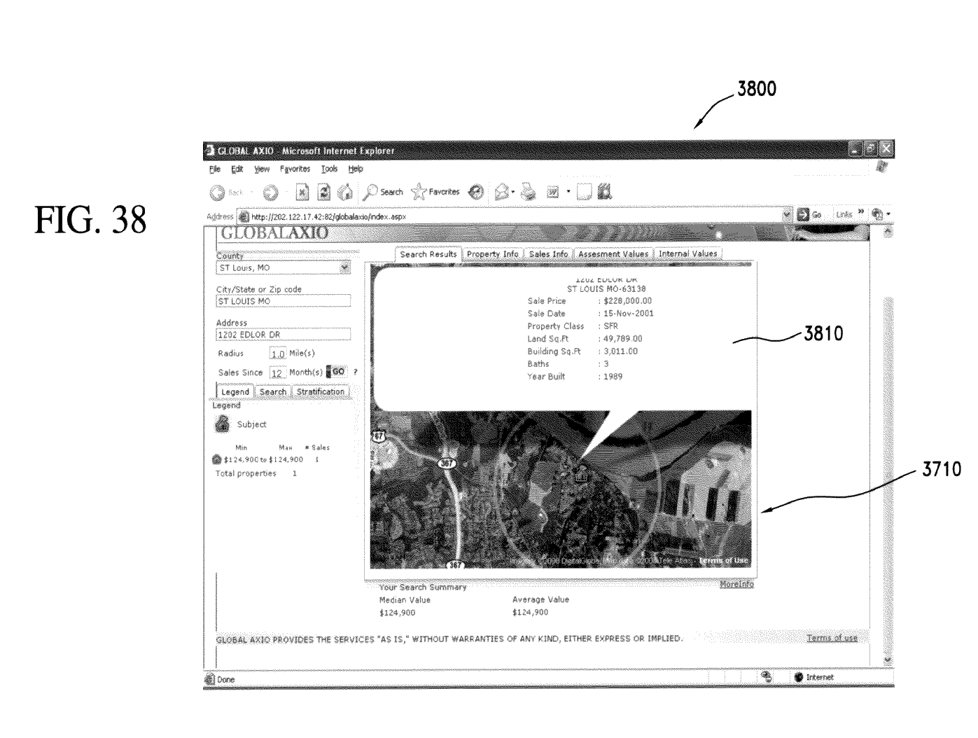

FIG. 38 is the screen shot of FIG. 37 showing information on the subject property, in accordance with an alternative embodiment of the present invention. In FIG. 38, a screen 3800 is shown with an information bubble 3810 containing information on the subject property superimposed over map 3710.

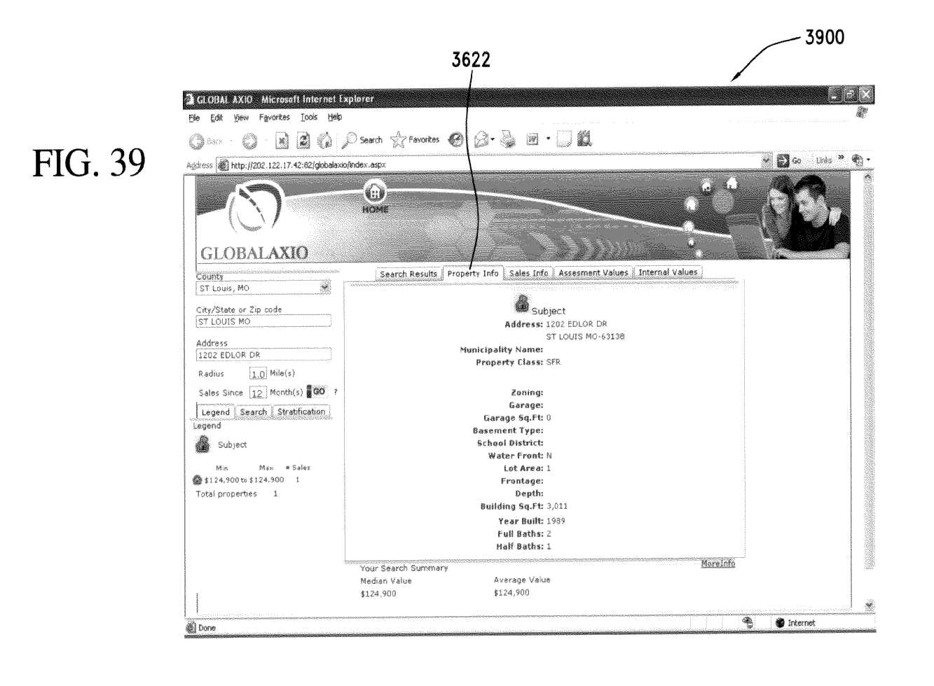

FIG. 39 is a screen shot of the system from FIG. 38 after selecting the Property Info tab, in accordance with an alternative embodiment of the present invention. In FIG. 39, a screen 3900 is shown displaying the property info tab 3622 with information on the subject property that may include, but is not limited to, the address of the subject property, the name of the municipality in which the property is located, the property class (i.e., type of building, either residential, commercial, single family, etc.), zoning, garage, garage square footage, basement type, school district, water front property, lot area, frontage, depth, building square feet, year built, number of full baths, number or half baths, etc.

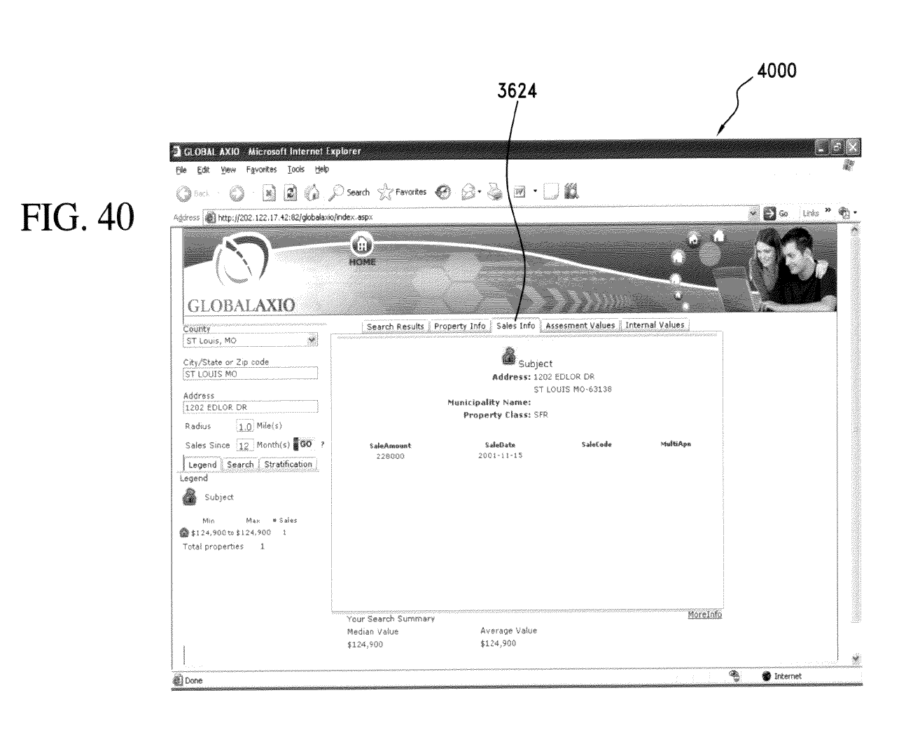

FIG. 40 is a screen shot of the system from FIG. 38 or 39 after selecting the Sales Info tab, in accordance with an alternative embodiment of the present invention. In FIG. 40, a screen 4000 is shown displaying the sales info tab 3623 with sales information on the subject property that may include, but is not limited to, the address of the subject property, the name of the municipality in which the property is located, the property class (i.e., type of building, either residential, commercial, single family, etc.), sale amount, sale date, sale code, etc.

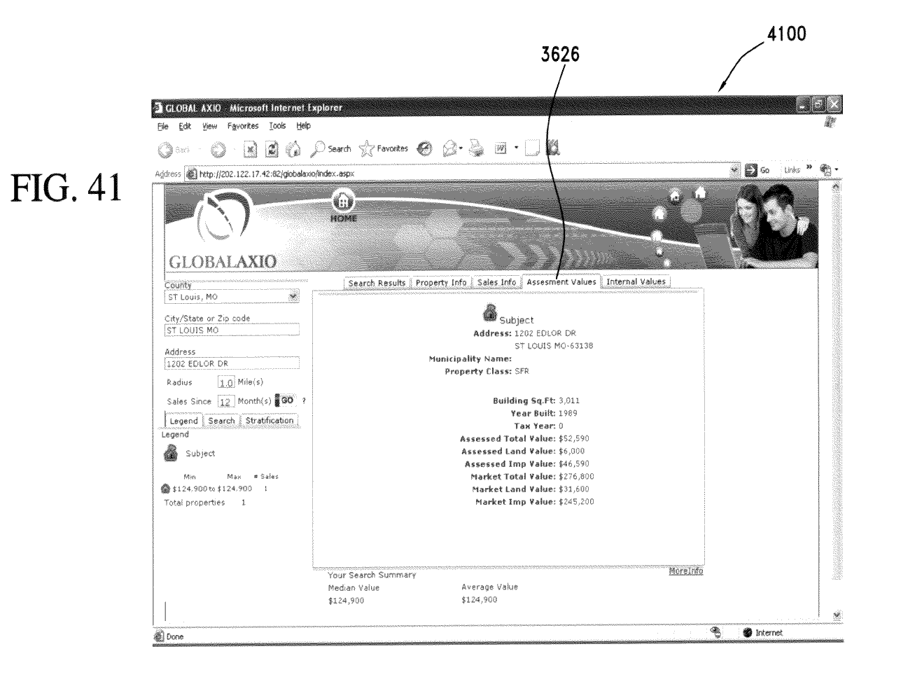

FIG. 41 is a screen shot of the system from FIG. 38, 39 or 40 after selecting the Assessment Values tab, in accordance with an alternative embodiment of the present invention. In FIG. 41, a screen 4100 is shown displaying the assessment values tab 3624 with tax assessment information on the subject property that may include, but is not limited to, the address of the subject property, the name of the municipality in which the property is located, the property class (i.e., type of building, either residential, commercial, single family, etc.), building square feet, year built, tax year, assessed total value, assessed land value, assessed improvement value, market total value, market land value, market improvement value, etc.

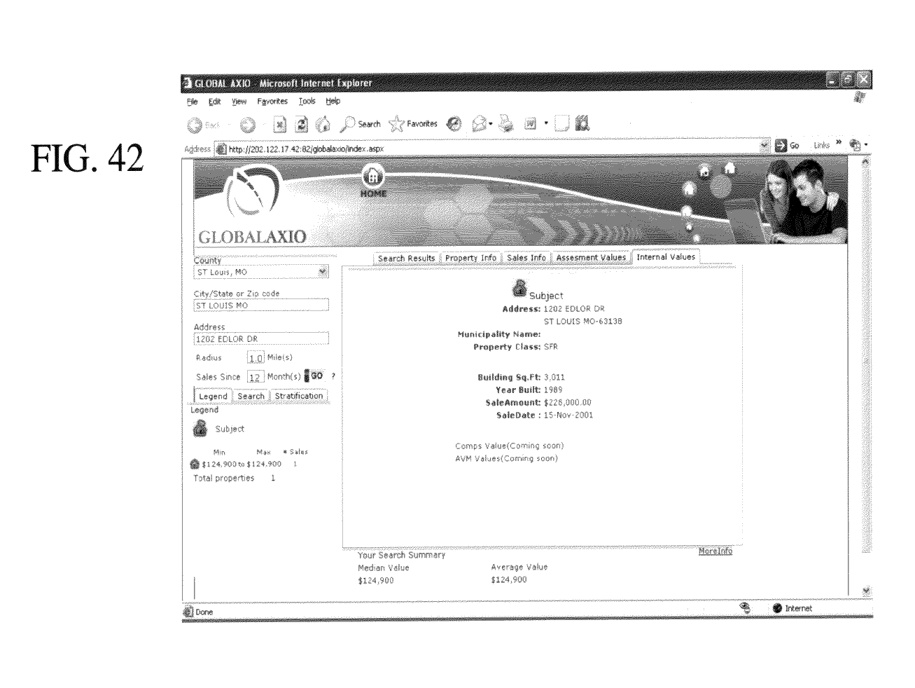

FIG. 42 is a screen shot of the system from FIG. 38, 39, 40 or 41 after selecting the Internal Values tab, in accordance with an alternative embodiment of the present invention. In FIG. 42, a screen 4200 is shown displaying the internal values tab 3625 with internal value information on the subject property that may include, but is not limited to, the address of the subject property, the name of the municipality in which the property is located, the property class (i.e., type of building, either residential, commercial, single family, etc.), building square feet, year built, tax year, assessed total value, assessed land value, assessed improvement value, market total value, market land value, market improvement value, etc.

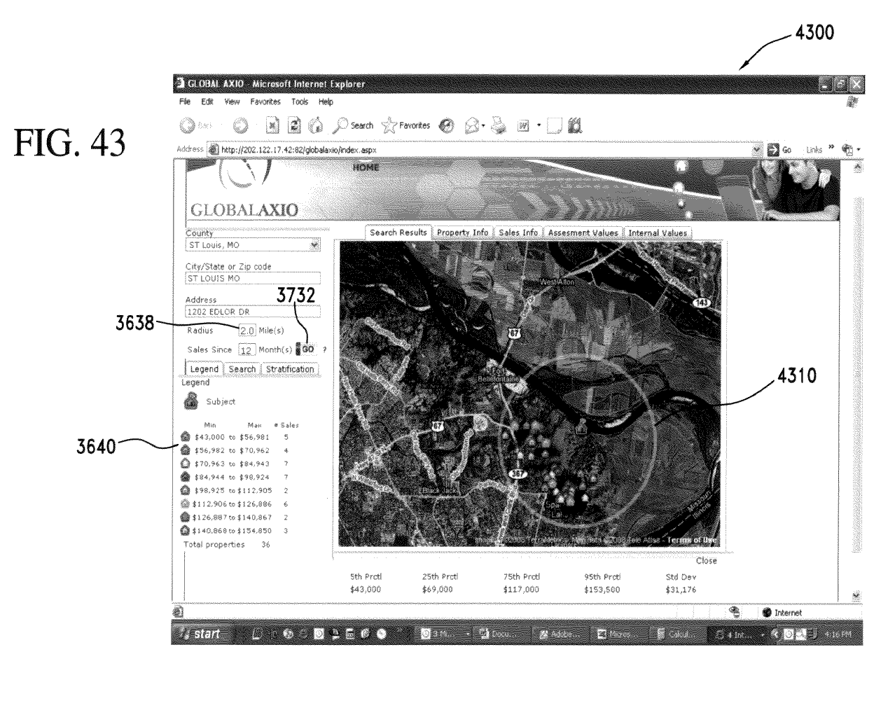

FIG. 43 is a screen shot of the system from FIG. 37 after changing the Radius search value from 1.0 miles to 2.0 miles, in accordance with an alternative embodiment of the present invention. In FIG. 43, a screen 4300 is shown displaying a map section 4310 with the results of a search for comparable properties within a territory with a two-mile radius, as indicated by the circle around the subject property. The new search is started by changing the value in the radius box 3638 from 1.0 to 2.0 and selecting the GO button 3732 by positioning the cursor over the GO button 3732 and clicking the left mouse button. As seen in the map section 4310, a significant number of comparable properties have now been located using the increased search radius. In fact, 36 comparable properties have been located and the distribution of the properties is shown in comparables information section 3640 and grouped by sales price ranges.

In accordance with an embodiment of the present invention, a method includes receiving a county selection; receiving a list of a plurality of subject properties in the selected county; receiving selection logic and adjustment logic; and identifying comparable properties with their associated data within a predefined territory around each of the plurality of subject properties using predefined variables and the received selection logic. The method further includes assigning a confidence level for each of the identified comparable properties for each of the plurality of subject properties; calculating a valuation for each of the plurality of subject properties based on the identified comparable properties and adjustment logic; and outputting a valuation for each of the plurality of subject properties with a listing of the comparable properties identified for the subject property along with a confidence level for the valuation based on the confidence level of each of the comparable properties used in the valuation.

In accordance with an embodiment of the present invention, a machine readable medium having stored thereon a plurality of executable instructions to perform a method including receiving a county selection; receiving a list of a plurality of subject properties in the selected county; receiving selection logic and adjustment logic; and identifying comparable properties with their associated data within a predefined territory around each of the plurality of subject properties using predefined variables and the received selection logic. The method further including assigning a confidence level for each of the identified comparable properties for each of the plurality of subject properties; calculating a valuation for each of the plurality of subject properties based on the identified comparable properties and adjustment logic; and outputting a valuation for each of the plurality of subject properties with a listing of the comparable properties identified for the subject property along with a confidence level for the valuation based on the confidence level of each of the comparable properties used in the valuation.

In accordance with an embodiment of the present invention, a system including a backend database system including a live database with a spatially-oriented real estate valuation and best comparables report generation system and recent comparables data, and a history database with historical comparables data; a front-end database system including at least one computer program for generating a spatially-oriented real estate valuation estimate for a subject property; a first firewall to enable communication between the backend database system and the front-end database system; and a second firewall to enable communication between the front-end database system and at least one user. The system further including the at least one computer program including a plurality of computer executable instructions that, when executed by a computer, perform a method including receiving a county selection; receiving a list of a plurality of subject properties in the selected county; receiving selection logic and adjustment logic; and identifying comparable properties with their associated data within a predefined territory around each of the plurality of subject properties using predefined variables and the received selection logic. The method further including assigning a confidence level for each of the identified comparable properties for each of the plurality of subject properties; calculating a valuation for each of the plurality of subject properties based on the identified comparable properties and adjustment logic; and outputting a valuation for each of the plurality of subject properties with a listing of the comparable properties identified for the subject property along with a confidence level for the valuation based on the confidence level of each of the comparable properties used in the valuation.

In accordance with one or more embodiments of the present invention, a spatially-oriented real estate valuation and best comparables report generation system and method, as substantially shown and described herein.

While the present invention has been described in conjunction with a number of embodiments, the invention is not to be limited to the description of the embodiments contained herein, but rather is defined by the claims appended hereto and their equivalents. It is further evident that many alternatives, modifications, and variations would be or are apparent to those of ordinary skill in the applicable arts. Accordingly, all such alternatives, modifications, equivalents, and variations that are within the spirit and scope of this invention.

What is claimed is:

1. A method comprising:
receiving a county selection;
receiving a list of a plurality of subject properties in the selected county;
receiving selection logic and adjustment logic;
identifying comparable properties with their associated data within a predefined territory around each of the plurality of subject properties using predefined variables and the received selection logic;
assigning a confidence level for each of the identified comparable properties for each of the plurality of subject properties;
calculating a valuation for each of the plurality of subject properties based on the identified comparable properties and adjustment logic; and
outputting a valuation for each of the plurality of subject properties with a listing of the comparable properties identified for the subject property along with a confidence level for the valuation based on the confidence level of each of the comparable properties used in the valuation.

2. The method of claim 1 wherein the receiving a county selection comprises at least one of:
selecting a county from a map with selectable icons; and
entering a county into an input box for county name and state.

3. The method of claim 1 wherein the receiving the list of a plurality of subject properties in the selected county comprises:
receiving a list of street addresses for the plurality of subject properties.

4. The method of claim 1 wherein receiving the selection logic comprises:
receiving ranges for specific attributes of the subject property.

5. The method of claim 1 wherein receiving the adjustment logic comprises:
receiving adjustment rules based on value ranges for specific attributes of the subject property.

6. The method of claim 1 wherein identifying comparable properties with their associated data within the predefined territory around each of the plurality of subject properties using predefined variables and the received selection logic comprises:
identifying comparable properties using predefined ranges of the variables and the selection logic.

7. The method of claim 7 wherein the identifying comparable properties using predefined ranges of the variables and the selection logic comprises:
identifying comparable properties based on the comparable property having at least a square feet of living space within the predefined range for the subject property.

8. The method of claim 1 wherein the calculating a valuation for each of the plurality of subject properties based on the identified comparable properties and adjustment logic comprises:
calculating a plurality of values for each subject property, each based on a different one of the comparable properties; and
calculating the valuation for each subject property based on combination of each of the plurality of values for the subject property.

9. A machine readable medium having stored thereon a plurality of executable instructions to perform a method comprising:
receiving a county selection;
receiving a list of a plurality of subject properties in the selected county;
receiving selection logic and adjustment logic;
identifying comparable properties with their associated data within a predefined territory around each of the plurality of subject properties using predefined variables and the received selection logic;
assigning a confidence level for each of the identified comparable properties for each of the plurality of subject properties;
calculating a valuation for each of the plurality of subject properties based on the identified comparable properties and adjustment logic; and
outputting a valuation for each of the plurality of subject properties with a listing of the comparable properties identified for the subject property along with a confidence level for the valuation based on the confidence level of each of the comparable properties used in the valuation.

10. The machine readable medium of claim 9 wherein the receiving a county selection comprises at least one of:
selecting a county from a map with selectable icons; and
entering a county into an input box for county name and state.

11. The machine readable medium of claim 9 wherein the receiving the list of a plurality of subject properties in the selected county comprises:
receiving a list of street addresses for the plurality of subject properties.

12. The machine readable medium of claim 9 wherein receiving the selection logic comprises:
receiving ranges for specific attributes of the subject property.

13. The machine readable medium of claim 9 wherein receiving the adjustment logic comprises:
receiving adjustment rules based on value ranges for specific attributes of the subject property.

14. The machine readable medium of 9 wherein identifying comparable properties with their associated data within the predefined territory around each of the plurality of subject properties using predefined variables and the received selection logic comprises:
identifying comparable properties using predefined ranges of the variables and the selection logic.

15. The method of claim 14 wherein the identifying comparable properties using predefined ranges of the variables and the selection logic comprises:
identifying comparable properties based on the comparable property having at least a square feet of living space within the predefined range for the subject property.

16. The method of claim 9 wherein the calculating a valuation for each of the plurality of subject properties based on the identified comparable properties and adjustment logic comprises:
calculating a plurality of values for each subject property, each based on a different one of the comparable properties; and
calculating the valuation for each subject property based on combination of each of the plurality of values for the subject property.

17. A system comprising:
a backend database system including a live database with a spatially-oriented real estate valuation and best comparables report generation system and recent comparables data, and a history database with historical comparables data;
a front-end database system including at least one computer program for generating a spatially-oriented real estate valuation estimate for a subject property;
a first firewall to enable communication between the backend database system and the front-end database system; and
a second firewall to enable communication between the front-end database system and at least one user;
the at least one computer program including a plurality of computer executable instructions that, when executed by a computer, perform the following method:
receiving a county selection;
receiving a list of a plurality of subject properties in the selected county;
receiving selection logic and adjustment logic;
identifying comparable properties with their associated data within a predefined territory around each of the plurality of subject properties using predefined variables and the received selection logic;
assigning a confidence level for each of the identified comparable properties for each of the plurality of subject properties;
calculating a valuation for each of the plurality of subject properties based on the identified comparable properties and adjustment logic; and
outputting a valuation for each of the plurality of subject properties with a listing of the comparable properties identified for the subject property along with a confidence level for the valuation based on the confidence level of each of the comparable properties used in the valuation.

18. The machine readable medium of claim 17 wherein the receiving a county selection comprises at least one of:
selecting a county from a map with selectable icons; and
entering a county into an input box for county name and state.

19. The machine readable medium of claim 17 wherein the receiving the list of a plurality of subject properties in the selected county comprises:
receiving a list of street addresses for the plurality of subject properties.

20. The machine readable medium of claim 17 wherein receiving the selection logic comprises:
receiving ranges for specific attributes of the subject property.

21. The machine readable medium of claim 17 wherein receiving the adjustment logic comprises:
receiving adjustment rules based on value ranges for specific attributes of the subject property.

22. The machine readable medium of 17 wherein identifying comparable properties with their associated data within the predefined territory around each of the plurality of subject properties using predefined variables and the received selection logic comprises:
identifying comparable properties using predefined ranges of the variables and the selection logic.

23. The method of claim 22 wherein the identifying comparable properties using predefined ranges of the variables and the selection logic comprises:
identifying comparable properties based on the comparable property having at least a square feet of living space within the predefined range for the subject property.
